(19) United States
(12) Patent Application Publication
(10) Pub. No.: US 2018/0357817 A1
(43) Pub. Date: Dec. 13, 2018

(54) INFORMATION PROCESSING METHOD, PROGRAM, AND COMPUTER

(71) Applicant: COLOPL, Inc., Tokyo (JP)

(72) Inventor: Hisashi IKEKITA, Tokyo (JP)

(21) Appl. No.: 16/005,116

(22) Filed: Jun. 11, 2018

(30) Foreign Application Priority Data
Jun. 12, 2017 (JP) 2017-115464

(51) Int. Cl. G06T 15/20; G06F 3/01; A63F 13/525; A63F 13/577

(52) U.S. Cl. CPC G06T 15/20; G06F 3/012; G06T 2215/16; A63F 13/577; G06T 2210/21; A63F 13/525

(57) ABSTRACT

An information processing method to be executed in a system including a head-mounted display and a sensor configured to detect a motion of the head-mounted display. The information processing method includes defining a virtual space, wherein the virtual space comprises a player character associated with a user, a virtual camera associated with a head of the player character, and a target object. The information processing method further includes identifying virtual space data defining the virtual space. The information processing method further includes detecting a motion of the head-mounted device (HMD) associated with the user. The information processing method further includes moving the virtual camera based on and in accordance with the motion of the HMD head-mounted display. The information processing method further includes identifying a speed of the HMD or the virtual camera. The information processing method further includes assigning and defining an element for applying a condition and an influence relating to collision determination between the player character and the target object based on information on the speed of the head-mounted display. The information processing method further includes identifying a positional relationship between the player character or the virtual camera and the target object. The information processing method further includes executing collision determination between the player character and the target object based on the condition, the assigned element, and a positional relationship between a collision area associated with the head of the player character or the virtual camera and the target object. The information processing method further includes controlling the virtual space in accordance with the collision determination. The information processing method further includes defining a visual field in the virtual space in accordance with the motion of the HMD. The information processing method further includes generating a visual-field image corresponding to the visual field. The information processing method further includes outputting the visual-field image to the HMD. The information processing method further includes generating field-of-view image data based on a field of view of the virtual camera defined based on a motion of the virtual camera, the virtual space data, and the collision determination result. The information processing method further includes displaying a field-of-view image on the head-mounted display based on the field-of-view image data.

### TECHNICAL FIELD

This disclosure relates to an information processing method, a program, and a computer.

### BACKGROUND

In Patent Document 1, there is described a technology involving varying the size of a collision area of a hand object in a virtual reality (VR) space in accordance with the velocity of a head-mounted display (HMD) worn on the head of the user in a real space, and generating a collision effect when the collision area and a target object collide with each other.

### PATENT DOCUMENTS

[Patent Document 1] JP 6118444 B1

### SUMMARY

According to at least one embodiment of this disclosure, there is provided an information processing method to be executed in a system including a head-mounted display and a sensor configured to detect a motion of the head-mounted display, the information processing method including: defining a virtual space, the virtual space including a player character associated with a user, a virtual camera associated with a head of the player character, and a target object; identifying virtual space data defining the virtual space; detecting a motion of a head-mounted device (HMD) associated with the user; moving the virtual camera based on and in accordance with the motion of the HMD head-mounted display; identifying a speed of the HMD or the virtual camera; assigning and defining an element for applying a condition and an influence relating to collision determination between the player character and the target object based on information on the speed of the head-mounted display; identifying a positional relationship between the player character or the virtual camera and the target object; executing collision determination between the player character and the target object based on the condition, the assigned element, and a positional relationship between a collision area associated with the head of the player character or the virtual camera and the target object; controlling the virtual space in accordance with the collision determination; defining a visual field in the virtual space in accordance with the motion of the HMD; generating a visual-field image corresponding to the visual field; outputting the visual-field image to the HMD; generating field-of-view image data based on a field of view of the virtual camera defined based on a motion of the virtual camera, the virtual space data, and the collision determination result; and displaying a field-of-view image on the head-mounted display based on the field-of-view image data.

### BRIEF DESCRIPTION OF THE DRAWINGS

FIG. 1 A diagram of a system including a head-mounted device (HMD) according to at least one embodiment of this disclosure.

FIG. 2 A block diagram of a hardware configuration of a computer according to at least one embodiment of this disclosure.

FIG. 3 A diagram of a uvw visual-field coordinate system to be set for an HMD according to at least one embodiment of this disclosure.

FIG. 4 A diagram of a mode of expressing a virtual space according to at least one embodiment of this disclosure.

FIG. 5 A diagram of a plan view of a head of a user wearing the HMD according to at least one embodiment of this disclosure.

FIG. 6 A diagram of a YZ cross section obtained by viewing a field-of-view region from an X direction in the virtual space according to at least one embodiment of this disclosure.

FIG. 7 A diagram of an XZ cross section obtained by viewing the field-of-view region from a Y direction in the virtual space according to at least one embodiment of this disclosure.

FIG. 8A A diagram of a schematic configuration of a controller according to at least one embodiment of this disclosure.

FIG. 8B A diagram of a coordinate system to be set for a hand of a user holding the controller according to at least one embodiment of this disclosure.

FIG. 9 A block diagram of a hardware configuration of a server according to at least one embodiment of this disclosure.

FIG. 10 A block diagram of a computer according to at least one embodiment of this disclosure.

FIG. 11 A sequence chart of processing to be executed by a system including an HMD set according to at least one embodiment of this disclosure.

FIG. 12A A schematic diagram of HMD systems of several users sharing the virtual space interact using a network according to at least one embodiment of this disclosure.

FIG. 12B A diagram of a field of view image of a HMD according to at least one embodiment of this disclosure.

FIG. 13 A sequence diagram of processing to be executed by a system including an HMD interacting in a network according to at least one embodiment of this disclosure.

FIG. 14 A block diagram of a detailed configuration of modules of the computer according to at least one embodiment of this disclosure.

FIG. 15 A flowchart of processing to be executed by the HMD system used by the user to provide a virtual space to the user according to at least one embodiment of this disclosure.

FIG. 16A A diagram of an example of the HMD device and the user wearing the controller according to at least one embodiment of this disclosure.

FIG. 16B A diagram of an example of a virtual camera arranged in the virtual space, a head object of a player character, a left hand object of the player character, a right hand object of the player character, and an enemy character according to at least one embodiment of this disclosure.

FIG. 17 A diagram of an example of a field-of-view image obtained by photographing the virtual space of FIG. 16B from the field-of-view region of the virtual camera according to at least one embodiment of this disclosure.

FIG. 18 A flowchart of an example of collision determination processing according to at least one embodiment of this disclosure.

FIG. 19A A diagram of an example of a state in which the user has moved his or her head backward according to at least one embodiment of this disclosure.

FIG. 19B A diagram of an example of control of a size of a collision area of the head object of the player character in the state of FIG. 19A according to at least one embodiment of this disclosure.

FIG. 20A A diagram of an example of a state in which the user has moved his or her head downward (state in which user is crouching) according to a modification example of this disclosure.

FIG. 20B A diagram of an example of control of the size of the collision area of the head object of the player character in the state of FIG. 20A according to a modification example of this disclosure.

FIG. 21 A flowchart of an example of collision determination processing according to a second embodiment of this disclosure.

FIG. 22A A diagram of an example of a state in which the user has moved his or her head forward according to the second embodiment of this disclosure.

FIG. 22B A diagram of an example of control of the size of the collision area of the head object of the player character in the state of FIG. 22A according to the second embodiment of this disclosure.

FIG. 23 A flowchart of an example of collision determination processing according to at a third embodiment of this disclosure.

### DETAILED DESCRIPTION

Now, with reference to the drawings, embodiments of this technical idea are described in detail. In the following description, like components are denoted by like reference symbols. The same applies to the names and functions of those components. Therefore, detailed description of those components is not repeated. In one or more embodiments described in this disclosure, components of respective embodiments can be combined with each other, and the combination also serves as a part of the embodiments described in this disclosure.

[Configuration of HMD System]

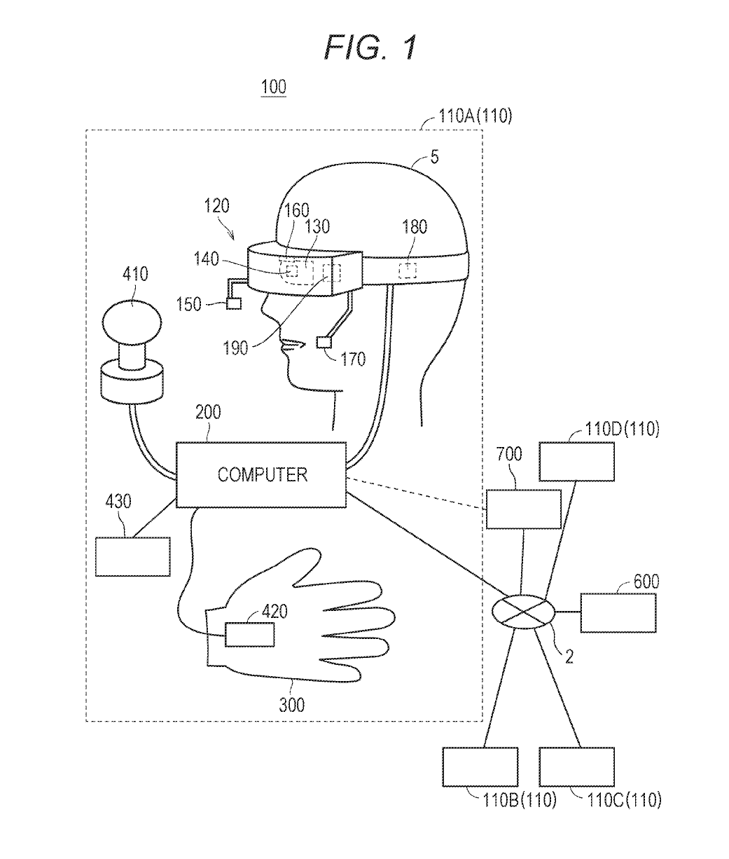

With reference to FIG. 1, a configuration of a head-mounted device (HMD) system 100 is described. FIG. 1 is a diagram of a system 100 including a head-mounted display (HMD) according to at least one embodiment of this disclosure. The system 100 is usable for household use or for professional use.

The system 100 includes a server 600, HMD sets 110A, 110B, 110C, and 110D, an external device 700, and a network 2. Each of the HMD sets 110A, 110B, 110C, and 110D is capable of independently communicating to/from the server 600 or the external device 700 via the network 2. In some instances, the HMD sets 110A, 110B, 110C, and 110D are also collectively referred to as “HMD set 110”. The number of HMD sets 110 constructing the HMD system 100 is not limited to four, but may be three or less, or five or more. The HMD set 110 includes an HMD 120, a computer 200, an HMD sensor 410, a display 430, and a controller 300. The HMD 120 includes a monitor 130, an eye gaze sensor 140, a first camera 150, a second camera 160, a microphone 170, and a speaker 180. In at least one embodiment, the controller 300 includes a motion sensor 420.

In at least one aspect, the computer 200 is connected to the network 2, for example, the Internet, and is able to communicate to/from the server 600 or other computers connected to the network 2 in a wired or wireless manner. Examples of the other computers include a computer of another HMD set 110 or the external device 700. In at least one aspect, the HMD 120 includes a sensor 190 instead of the HMD sensor 410. In at least one aspect, the HMD 120 includes both sensor 190 and the HMD sensor 410.

The HMD 120 is wearable on a head of a user 5 to display a virtual space to the user 5 during operation. More specifically, in at least one embodiment, the HMD 120 displays each of a right-eye image and a left-eye image on the monitor 130. Each eye of the user 5 is able to visually recognize a corresponding image from the right-eye image and the left-eye image so that the user 5 may recognize a three-dimensional image based on the parallax of both of the user's the eyes. In at least one embodiment, the HMD 120 includes any one of a so-called head-mounted display including a monitor or a head-mounted device capable of mounting a smartphone or other terminals including a monitor.

The monitor 130 is implemented as, for example, a non-transmissive display device. In at least one aspect, the monitor 130 is arranged on a main body of the HMD 120 so as to be positioned in front of both the eyes of the user 5. Therefore, when the user 5 is able to visually recognize the three-dimensional image displayed by the monitor 130, the user 5 is immersed in the virtual space. In at least one aspect, the virtual space includes, for example, a background, objects that are operable by the user 5, or menu images that are selectable by the user 5. In at least one aspect, the monitor 130 is implemented as a liquid crystal monitor or an organic electroluminescence (EL) monitor included in a so-called smartphone or other information display terminals.

In at least one aspect, the monitor 130 is implemented as a transmissive display device. In this case, the user 5 is able to see through the HMD 120 covering the eyes of the user 5, for example, smart glasses. In at least one embodiment, the transmissive monitor 130 is configured as a temporarily non-transmissive display device through adjustment of a transmittance thereof. In at least one embodiment, the monitor 130 is configured to display a real space and a part of an image constructing the virtual space simultaneously. For example, in at least one embodiment, the monitor 130 displays an image of the real space captured by a camera mounted on the HMD 120, or may enable recognition of the real space by setting the transmittance of a part the monitor 130 sufficiently high to permit the user 5 to see through the HMD 120.

In at least one aspect, the monitor 130 includes a sub-monitor for displaying a right-eye image and a sub-monitor for displaying a left-eye image. In at least one aspect, the monitor 130 is configured to integrally display the right-eye image and the left-eye image. In this case, the monitor 130 includes a high-speed shutter. The high-speed shutter operates so as to alternately display the right-eye image to the right of the user 5 and the left-eye image to the left eye of the user 5, so that only one of the user's 5 eyes is able to recognize the image at any single point in time.

In at least one aspect, the HMD 120 includes a plurality of light sources (not shown). Each light source is implemented by, for example, a light emitting diode (LED) configured to emit an infrared ray. The HMD sensor 410 has a position tracking function for detecting the motion of the HMD 120. More specifically, the HMD sensor 410 reads a plurality of infrared rays emitted by the HMD 120 to detect the position and the inclination of the HMD 120 in the real space.

In at least one aspect, the HMD sensor 410 is implemented by a camera. In at least one aspect, the HMD sensor 410 uses image information of the HMD 120 output from the camera to execute image analysis processing, to thereby enable detection of the position and the inclination of the HMD 120.

In at least one aspect, the HMD 120 includes the sensor 190 instead of, or in addition to, the HMD sensor 410 as a position detector. In at least one aspect, the HMD 120 uses the sensor 190 to detect the position and the inclination of the HMD 120. For example, in at least one embodiment, when the sensor 190 is an angular velocity sensor, a geomagnetic sensor, or an acceleration sensor, the HMD 120 uses any or all of those sensors instead of (or in addition to) the HMD sensor 410 to detect the position and the inclination of the HMD 120. As an example, when the sensor 190 is an angular velocity sensor, the angular velocity sensor detects over time the angular velocity about each of three axes of the HMD 120 in the real space. The HMD 120 calculates a temporal change of the angle about each of the three axes of the HMD 120 based on each angular velocity, and further calculates an inclination of the HMD 120 based on the temporal change of the angles.

The eye gaze sensor 140 detects a direction in which the lines of sight of the right eye and the left eye of the user 5 are directed. That is, the eye gaze sensor 140 detects the line of sight of the user 5. The direction of the line of sight is detected by, for example, a known eye tracking function. The eye gaze sensor 140 is implemented by a sensor having the eye tracking function. In at least one aspect, the eye gaze sensor 140 includes a right-eye sensor and a left-eye sensor. In at least one embodiment, the eye gaze sensor 140 is, for example, a sensor configured to irradiate the right eye and the left eye of the user 5 with an infrared ray, and to receive reflection light from the cornea and the iris with respect to the irradiation light, to thereby detect a rotational angle of each of the user's 5 eyeballs. In at least one embodiment, the eye gaze sensor 140 detects the line of sight of the user 5 based on each detected rotational angle.

The first camera 150 photographs a lower part of a face of the user 5. More specifically, the first camera 150 photographs, for example, the nose or mouth of the user 5. The second camera 160 photographs, for example, the eyes and eyebrows of the user 5. A side of a casing of the HMD 120 on the user 5 side is defined as an interior side of the HMD 120, and a side of the casing of the HMD 120 on a side opposite to the user 5 side is defined as an exterior side of the HMD 120. In at least one aspect, the first camera 150 is arranged on an exterior side of the HMD 120, and the second camera 160 is arranged on an interior side of the HMD 120. Images generated by the first camera 150 and the second camera 160 are input to the computer 200. In at least one aspect, the first camera 150 and the second camera 160 are implemented as a single camera, and the face of the user 5 is photographed with this single camera.

The microphone 170 converts an utterance of the user 5 into a voice signal (electric signal) for output to the computer 200. The speaker 180 converts the voice signal into a voice for output to the user 5. In at least one embodiment, the speaker 180 converts other signals into audio information provided to the user 5. In at least one aspect, the HMD 120 includes earphones in place of the speaker 180.

The controller 300 is connected to the computer 200 through wired or wireless communication. The controller 300 receives input of a command from the user 5 to the computer 200. In at least one aspect, the controller 300 is held by the user 5. In at least one aspect, the controller 300 is mountable to the body or a part of the clothes of the user 5. In at least one aspect, the controller 300 is configured to output at least any one of a vibration, a sound, or light based on the signal transmitted from the computer 200. In at least one aspect, the controller 300 receives from the user 5 an operation for controlling the position and the motion of an object arranged in the virtual space.

In at least one aspect, the controller 300 includes a plurality of light sources. Each light source is implemented by, for example, an LED configured to emit an infrared ray. The HMD sensor 410 has a position tracking function. In this case, the HMD sensor 410 reads a plurality of infrared rays emitted by the controller 300 to detect the position and the inclination of the controller 300 in the real space. In at least one aspect, the HMD sensor 410 is implemented by a camera. In this case, the HMD sensor 410 uses image information of the controller 300 output from the camera to execute image analysis processing, to thereby enable detection of the position and the inclination of the controller 300.

In at least one aspect, the motion sensor 420 is mountable on the hand of the user 5 to detect the motion of the hand of the user 5. For example, the motion sensor 420 detects a rotational speed, a rotation angle, and the number of rotations of the hand. The detected signal is transmitted to the computer 200. The motion sensor 420 is provided to, for example, the controller 300. In at least one aspect, the motion sensor 420 is provided to, for example, the controller 300 capable of being held by the user 5. In at least one aspect, to help prevent accidently release of the controller 300 in the real space, the controller 300 is mountable on an object like a glove-type object that does not easily fly away by being worn on a hand of the user 5. In at least one aspect, a sensor that is not mountable on the user 5 detects the motion of the hand of the user 5. For example, a signal of a camera that photographs the user 5 may be input to the computer 200 as a signal representing the motion of the user 5. As at least one example, the motion sensor 420 and the computer 200 are connected to each other through wired or wireless communication. In the case of wireless communication, the communication mode is not particularly limited, and for example, Bluetooth (trademark) or other known communication methods are usable.

The display 430 displays an image similar to an image displayed on the monitor 130. With this, a user other than the user 5 wearing the HMD 120 can also view an image similar to that of the user 5. An image to be displayed on the display 430 is not required to be a three-dimensional image, but may be a right-eye image or a left-eye image. For example, a liquid crystal display or an organic EL monitor may be used as the display 430.

In at least one embodiment, the server 600 transmits a program to the computer 200. In at least one aspect, the server 600 communicates to/from another computer 200 for providing virtual reality to the HMD 120 used by another user. For example, when a plurality of users play a participatory game, for example, in an amusement facility, each computer 200 communicates to/from another computer 200 via the server 600 with a signal that is based on the motion of each user, to thereby enable the plurality of users to enjoy a common game in the same virtual space. Each computer 200 may communicate to/from another computer 200 with the signal that is based on the motion of each user without intervention of the server 600.

The external device 700 is any suitable device as long as the external device 700 is capable of communicating to/from the computer 200. The external device 700 is, for example, a device capable of communicating to/from the computer 200 via the network 2, or is a device capable of directly communicating to/from the computer 200 by near field communication or wired communication. Peripheral devices such as a smart device, a personal computer (PC), or the computer 200 are usable as the external device 700, in at least one embodiment, but the external device 700 is not limited thereto.

[Hardware Configuration of Computer]

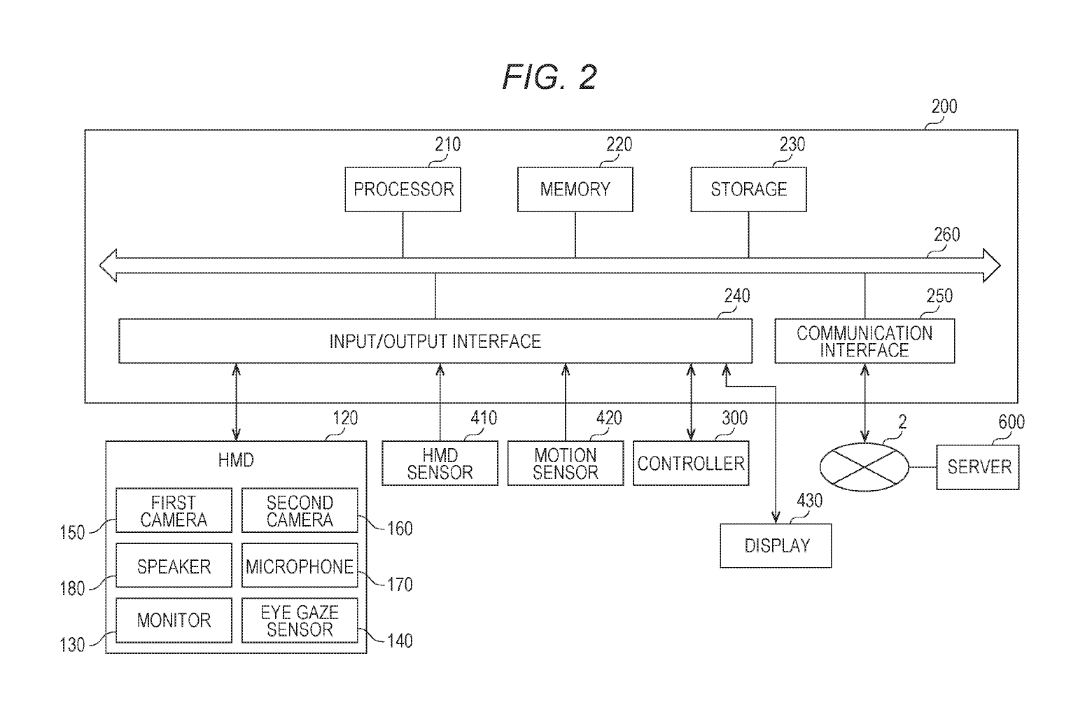

With reference to FIG. 2, the computer 200 in at least one embodiment is described. FIG. 2 is a block diagram of a hardware configuration of the computer 200 according to at least one embodiment. The computer 200 includes, a processor 210, a memory 220, a storage 230, an input/output interface 240, and a communication interface 250. Each component is connected to a bus 260. In at least one embodiment, at least one of the processor 210, the memory 220, the storage 230, the input/output interface 240 or the communication interface 250 is part of a separate structure and communicates with other components of computer 200 through a communication path other than the bus 260.

The processor 210 executes a series of commands included in a program stored in the memory 220 or the storage 230 based on a signal transmitted to the computer 200 or in response to a condition determined in advance. In at least one aspect, the processor 210 is implemented as a central processing unit (CPU), a graphics processing unit (GPU), a micro-processor unit (MPU), a field-programmable gate array (FPGA), or other devices.

The memory 220 temporarily stores programs and data. The programs are loaded from, for example, the storage 230. The data includes data input to the computer 200 and data generated by the processor 210. In at least one aspect, the memory 220 is implemented as a random access memory (RAM) or other volatile memories.

The storage 230 permanently stores programs and data. In at least one embodiment, the storage 230 stores programs and data for a period of time longer than the memory 220, but not permanently. The storage 230 is implemented as, for example, a read-only memory (ROM), a hard disk device, a flash memory, or other non-volatile storage devices. The programs stored in the storage 230 include programs for providing a virtual space in the system 100, simulation programs, game programs, user authentication programs, and programs for implementing communication to/from other computers 200. The data stored in the storage 230 includes data and objects for defining the virtual space.

In at least one aspect, the storage 230 is implemented as a removable storage device like a memory card. In at least one aspect, a configuration that uses programs and data stored in an external storage device is used instead of the storage 230 built into the computer 200. With such a configuration, for example, in a situation in which a plurality of HMD systems 100 are used, for example in an amusement facility, the programs and the data are collectively updated.

The input/output interface 240 allows communication of signals among the HMD 120, the HMD sensor 410, the motion sensor 420, and the display 430. The monitor 130, the eye gaze sensor 140, the first camera 150, the second camera 160, the microphone 170, and the speaker 180 included in the HMD 120 may communicate to/from the computer 200 via the input/output interface 240 of the HMD 120. In at least one aspect, the input/output interface 240 is implemented with use of a universal serial bus (USB), a digital visual interface (DVI), a high-definition multimedia interface (HDMI) (trademark), or other terminals. The input/output interface 240 is not limited to the specific examples described above.

In at least one aspect, the input/output interface 240 further communicates to/from the controller 300. For example, the input/output interface 240 receives input of a signal output from the controller 300 and the motion sensor 420. In at least one aspect, the input/output interface 240 transmits a command output from the processor 210 to the controller 300. The command instructs the controller 300 to, for example, vibrate, output a sound, or emit light. When the controller 300 receives the command, the controller 300 executes any one of vibration, sound output, and light emission in accordance with the command.

The communication interface 250 is connected to the network 2 to communicate to/from other computers (e.g., server 600) connected to the network 2. In at least one aspect, the communication interface 250 is implemented as, for example, a local area network (LAN), other wired communication interfaces, wireless fidelity (Wi-Fi), Bluetooth®, near field communication (NFC), or other wireless communication interfaces. The communication interface 250 is not limited to the specific examples described above.

In at least one aspect, the processor 210 accesses the storage 230 and loads one or more programs stored in the storage 230 to the memory 220 to execute a series of commands included in the program. In at least one embodiment, the one or more programs includes an operating system of the computer 200, an application program for providing a virtual space, and/or game software that is executable in the virtual space. The processor 210 transmits a signal for providing a virtual space to the HMD 120 via the input/output interface 240. The HMD 120 displays a video on the monitor 130 based on the signal.

In FIG. 2, the computer 200 is outside of the HMD 120, but in at least one aspect, the computer 200 is integral with the HMD 120. As an example, a portable information communication terminal (e.g., smartphone) including the monitor 130 functions as the computer 200 in at least one embodiment.

In at least one embodiment, the computer 200 is used in common with a plurality of HMDs 120. With such a configuration, for example, the computer 200 is able to provide the same virtual space to a plurality of users, and hence each user can enjoy the same application with other users in the same virtual space.

According to at least one embodiment of this disclosure, in the system 100, a real coordinate system is set in advance. The real coordinate system is a coordinate system in the real space. The real coordinate system has three reference directions (axes) that are respectively parallel to a vertical direction, a horizontal direction orthogonal to the vertical direction, and a front-rear direction orthogonal to both of the vertical direction and the horizontal direction in the real space. The horizontal direction, the vertical direction (up-down direction), and the front-rear direction in the real coordinate system are defined as an x axis, a y axis, and a z axis, respectively. More specifically, the x axis of the real coordinate system is parallel to the horizontal direction of the real space, the y axis thereof is parallel to the vertical direction of the real space, and the z axis thereof is parallel to the front-rear direction of the real space.

In at least one aspect, the HMD sensor 410 includes an infrared sensor. When the infrared sensor detects the infrared ray emitted from each light source of the HMD 120, the infrared sensor detects the presence of the HMD 120. The HMD sensor 410 further detects the position and the inclination (direction) of the HMD 120 in the real space, which corresponds to the motion of the user 5 wearing the HMD 120, based on the value of each point (each coordinate value in the real coordinate system). In more detail, the HMD sensor 410 is able to detect the temporal change of the position and the inclination of the HMD 120 with use of each value detected over time.

Each inclination of the HMD 120 detected by the HMD sensor 410 corresponds to an inclination about each of the three axes of the HMD 120 in the real coordinate system. The HMD sensor 410 sets a uvw visual-field coordinate system to the HMD 120 based on the inclination of the HMD 120 in the real coordinate system. The uvw visual-field coordinate system set to the HMD 120 corresponds to a point-of-view coordinate system used when the user 5 wearing the HMD 120 views an object in the virtual space.

[Uvw Visual-Field Coordinate System]

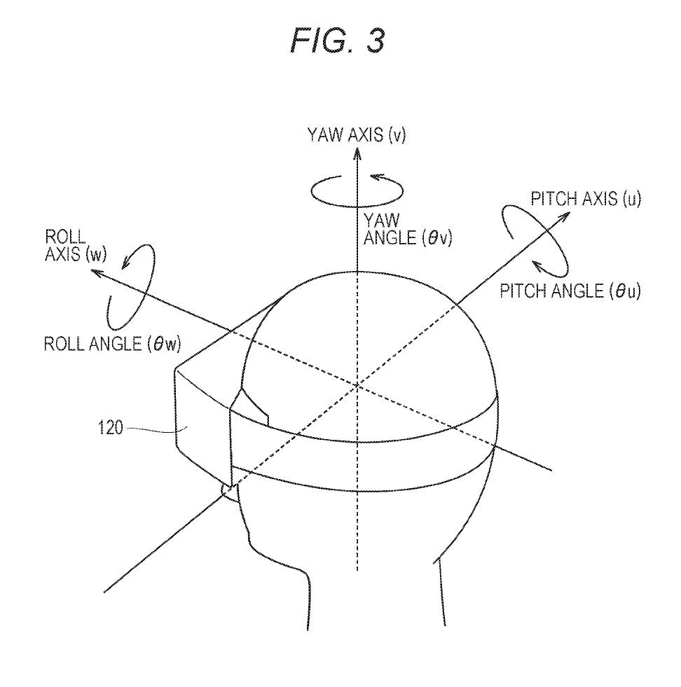

With reference to FIG. 3, the uvw visual-field coordinate system is described. FIG. 3 is a diagram of a uvw visual-field coordinate system to be set for the HMD 120 according to at least one embodiment of this disclosure. The HMD sensor 410 detects the position and the inclination of the HMD 120 in the real coordinate system when the HMD 120 is activated. The processor 210 sets the uvw visual-field coordinate system to the HMD 120 based on the detected values.

In FIG. 3, the HMD 120 sets the three-dimensional uvw visual-field coordinate system defining the head of the user 5 wearing the HMD 120 as a center (origin). More specifically, the HMD 120 sets three directions newly obtained by inclining the horizontal direction, the vertical direction, and the front-rear direction (x axis, y axis, and z axis), which define the real coordinate system, about the respective axes by the inclinations about the respective axes of the HMD 120 in the real coordinate system, as a pitch axis (u axis), a yaw axis (v axis), and a roll axis (w axis) of the uvw visual-field coordinate system in the HMD 120.

In at least one aspect, when the user 5 wearing the HMD 120 is standing (or sitting) upright and is visually recognizing the front side, the processor 210 sets the uvw visual-field coordinate system that is parallel to the real coordinate system to the HMD 120. In this case, the horizontal direction (x axis), the vertical direction (y axis), and the front-rear direction (z axis) of the real coordinate system directly match the pitch axis (u axis), the yaw axis (v axis), and the roll axis (w axis) of the uvw visual-field coordinate system in the HMD 120, respectively.

After the uvw visual-field coordinate system is set to the HMD 120, the HMD sensor 410 is able to detect the inclination of the HMD 120 in the set uvw visual-field coordinate system based on the motion of the HMD 120. In this case, the HMD sensor 410 detects, as the inclination of the HMD 120, each of a pitch angle (θu), a yaw angle (θv), and a roll angle (θw) of the HMD 120 in the uvw visual-field coordinate system. The pitch angle (θu) represents an inclination angle of the HMD 120 about the pitch axis in the uvw visual-field coordinate system. The yaw angle (θv) represents an inclination angle of the HMD 120 about the yaw axis in the uvw visual-field coordinate system. The roll angle (θw) represents an inclination angle of the HMD 120 about the roll axis in the uvw visual-field coordinate system.

The HMD sensor 410 sets, to the HMD 120, the uvw visual-field coordinate system of the HMD 120 obtained after the movement of the HMD 120 based on the detected inclination angle of the HMD 120. The relationship between the HMD 120 and the uvw visual-field coordinate system of the HMD 120 is constant regardless of the position and the inclination of the HMD 120. When the position and the inclination of the HMD 120 change, the position and the inclination of the uvw visual-field coordinate system of the HMD 120 in the real coordinate system change in synchronization with the change of the position and the inclination.

In at least one aspect, the HMD sensor 410 identifies the position of the HMD 120 in the real space as a position relative to the HMD sensor 410 based on the light intensity of the infrared ray or a relative positional relationship between a plurality of points (e.g., distance between points), which is acquired based on output from the infrared sensor. In at least one aspect, the processor 210 determines the origin of the uvw visual-field coordinate system of the HMD 120 in the real space (real coordinate system) based on the identified relative position.

[Virtual Space]

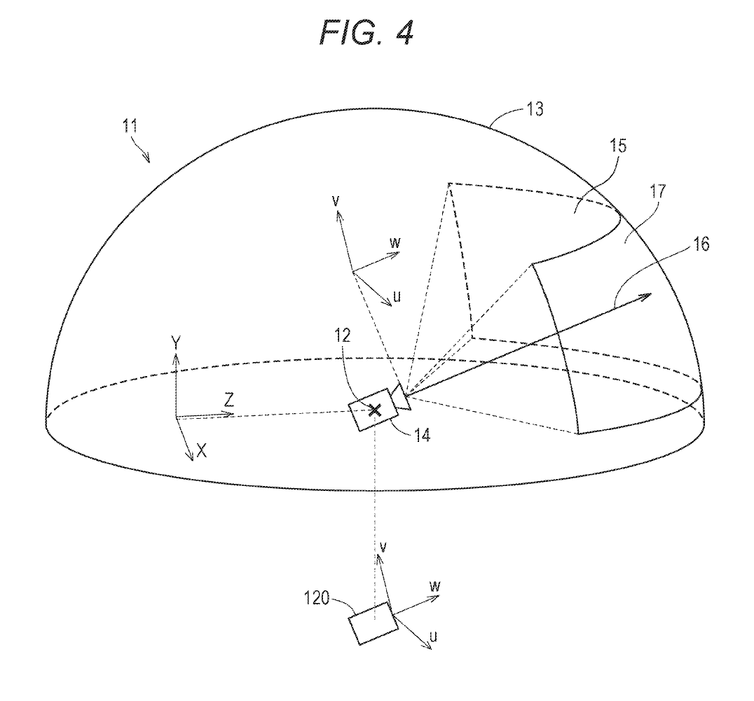

With reference to FIG. 4, the virtual space is further described. FIG. 4 is a diagram of a mode of expressing a virtual space 11 according to at least one embodiment of this disclosure. The virtual space 11 has a structure with an entire celestial sphere shape covering a center 12 in all 360-degree directions. In FIG. 4, for the sake of clarity, only the upper-half celestial sphere of the virtual space 11 is included. Each mesh section is defined in the virtual space 11. The position of each mesh section is defined in advance as coordinate values in an XYZ coordinate system, which is a global coordinate system defined in the virtual space 11. The computer 200 associates each partial image forming a panorama image 13 (e.g., still image or moving image) that is developed in the virtual space 11 with each corresponding mesh section in the virtual space 11.

In at least one aspect, in the virtual space 11, the XYZ coordinate system having the center 12 as the origin is defined. The XYZ coordinate system is, for example, parallel to the real coordinate system. The horizontal direction, the vertical direction (up-down direction), and the front-rear direction of the XYZ coordinate system are defined as an X axis, a Y axis, and a Z axis, respectively. Thus, the X axis (horizontal direction) of the XYZ coordinate system is parallel to the x axis of the real coordinate system, the Y axis (vertical direction) of the XYZ coordinate system is parallel to the y axis of the real coordinate system, and the Z axis (front-rear direction) of the XYZ coordinate system is parallel to the z axis of the real coordinate system.

When the HMD 120 is activated, that is, when the HMD 120 is in an initial state, a virtual camera 14 is arranged at the center 12 of the virtual space 11. In at least one embodiment, the virtual camera 14 is offset from the center 12 in the initial state. In at least one aspect, the processor 210 displays on the monitor 130 of the HMD 120 an image photographed by the virtual camera 14. In synchronization with the motion of the HMD 120 in the real space, the virtual camera 14 similarly moves in the virtual space 11. With this, the change in position and direction of the HMD 120 in the real space is reproduced similarly in the virtual space 11.

The uvw visual-field coordinate system is defined in the virtual camera 14 similarly to the case of the HMD 120. The uvw visual-field coordinate system of the virtual camera 14 in the virtual space 11 is defined to be synchronized with the uvw visual-field coordinate system of the HMD 120 in the real space (real coordinate system). Therefore, when the inclination of the HMD 120 changes, the inclination of the virtual camera 14 also changes in synchronization therewith. The virtual camera 14 can also move in the virtual space 11 in synchronization with the movement of the user 5 wearing the HMD 120 in the real space.

The processor 210 of the computer 200 defines a field-of-view region 15 in the virtual space 11 based on the position and inclination (reference line of sight 16) of the virtual camera 14. The field-of-view region 15 corresponds to, of the virtual space 11, the region that is visually recognized by the user 5 wearing the HMD 120. That is, the position of the virtual camera 14 determines a point of view of the user 5 in the virtual space 11.

The line of sight of the user 5 detected by the eye gaze sensor 140 is a direction in the point-of-view coordinate system obtained when the user 5 visually recognizes an object. The uvw visual-field coordinate system of the HMD 120 is equal to the point-of-view coordinate system used when the user 5 visually recognizes the monitor 130. The uvw visual-field coordinate system of the virtual camera 14 is synchronized with the uvw visual-field coordinate system of the HMD 120. Therefore, in the system 100 in at least one aspect, the line of sight of the user 5 detected by the eye gaze sensor 140 can be regarded as the line of sight of the user 5 in the uvw visual-field coordinate system of the virtual camera 14.

[User's Line of Sight]

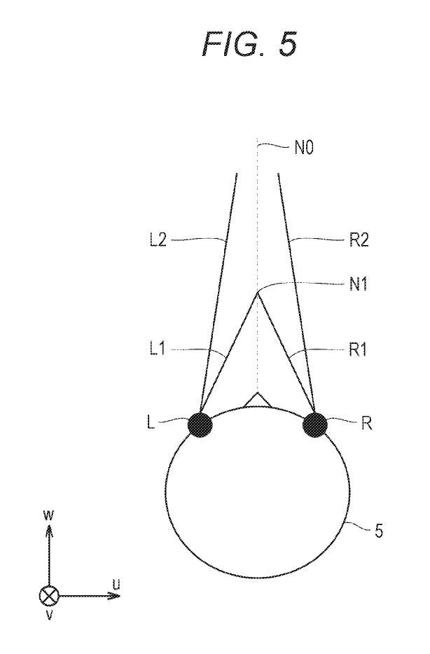

With reference to FIG. 5, determination of the line of sight of the user 5 is described. FIG. 5 is a plan view diagram of the head of the user 5 wearing the HMD 120 according to at least one embodiment of this disclosure.

In at least one aspect, the eye gaze sensor 140 detects lines of sight of the right eye and the left eye of the user 5. In at least one aspect, when the user 5 is looking at a near place, the eye gaze sensor 140 detects lines of sight R1 and L1. In at least one aspect, when the user 5 is looking at a far place, the eye gaze sensor 140 detects lines of sight R2 and L2. In this case, the angles formed by the lines of sight R2 and L2 with respect to the roll axis w are smaller than the angles formed by the lines of sight R1 and L1 with respect to the roll axis w. The eye gaze sensor 140 transmits the detection results to the computer 200.

When the computer 200 receives the detection values of the lines of sight R1 and L1 from the eye gaze sensor 140 as the detection results of the lines of sight, the computer 200 identifies a point of gaze N1 being an intersection of both the lines of sight R1 and L1 based on the detection values. Meanwhile, when the computer 200 receives the detection values of the lines of sight R2 and L2 from the eye gaze sensor 140, the computer 200 identifies an intersection of both the lines of sight R2 and L2 as the point of gaze. The computer 200 identifies a line of sight N0 of the user 5 based on the identified point of gaze N1. The computer 200 detects, for example, an extension direction of a straight line that passes through the point of gaze N1 and a midpoint of a straight line connecting a right eye R and a left eye L of the user 5 to each other as the line of sight N0. The line of sight N0 is a direction in which the user 5 actually directs his or her lines of sight with both eyes. The line of sight N0 corresponds to a direction in which the user 5 actually directs his or her lines of sight with respect to the field-of-view region 15.

In at least one aspect, the system 100 includes a television broadcast reception tuner. With such a configuration, the system 100 is able to display a television program in the virtual space 11.

In at least one aspect, the HMD system 100 includes a communication circuit for connecting to the Internet or has a verbal communication function for connecting to a telephone line or a cellular service.

[Field-of-View Region]

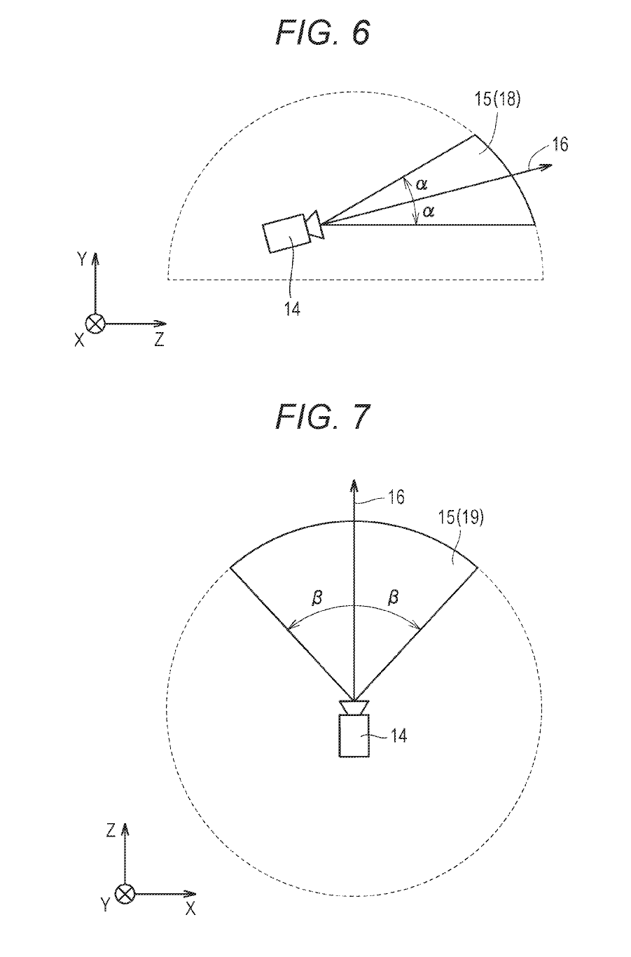

With reference to FIG. 6 and FIG. 7, the field-of-view region 15 is described. FIG. 6 is a diagram of a YZ cross section obtained by viewing the field-of-view region 15 from an X direction in the virtual space 11. FIG. 7 is a diagram of an XZ cross section obtained by viewing the field-of-view region 15 from a Y direction in the virtual space 11.

In FIG. 6, the field-of-view region 15 in the YZ cross section includes a region 18. The region 18 is defined by the position of the virtual camera 14, the reference line of sight 16, and the YZ cross section of the virtual space 11. The processor 210 defines a range of a polar angle α from the reference line of sight 16 serving as the center in the virtual space as the region 18.

In FIG. 7, the field-of-view region 15 in the XZ cross section includes a region 19. The region 19 is defined by the position of the virtual camera 14, the reference line of sight 16, and the XZ cross section of the virtual space 11. The processor 210 defines a range of an azimuth β from the reference line of sight 16 serving as the center in the virtual space 11 as the region 19. The polar angle α and β are determined in accordance with the position of the virtual camera 14 and the inclination (direction) of the virtual camera 14.

In at least one aspect, the system 100 causes the monitor 130 to display a field-of-view image 17 based on the signal from the computer 200, to thereby provide the field of view in the virtual space 11 to the user 5. The field-of-view image 17 corresponds to apart of the panorama image 13, which corresponds to the field-of-view region 15. When the user 5 moves the HMD 120 worn on his or her head, the virtual camera 14 is also moved in synchronization with the movement. As a result, the position of the field-of-view region 15 in the virtual space 11 is changed. With this, the field-of-view image 17 displayed on the monitor 130 is updated to an image of the panorama image 13, which is superimposed on the field-of-view region 15 synchronized with a direction in which the user 5 faces in the virtual space 11. The user 5 can visually recognize a desired direction in the virtual space 11.

In this way, the inclination of the virtual camera 14 corresponds to the line of sight of the user 5 (reference line of sight 16) in the virtual space 11, and the position at which the virtual camera 14 is arranged corresponds to the point of view of the user 5 in the virtual space 11. Therefore, through the change of the position or inclination of the virtual camera 14, the image to be displayed on the monitor 130 is updated, and the field of view of the user 5 is moved.

While the user 5 is wearing the HMD 120 (having a non-transmissive monitor 130), the user 5 can visually recognize only the panorama image 13 developed in the virtual space 11 without visually recognizing the real world. Therefore, the system 100 provides a high sense of immersion in the virtual space 11 to the user 5.

In at least one aspect, the processor 210 moves the virtual camera 14 in the virtual space 11 in synchronization with the movement in the real space of the user 5 wearing the HMD 120. In this case, the processor 210 identifies an image region to be projected on the monitor 130 of the HMD 120 (field-of-view region 15) based on the position and the direction of the virtual camera 14 in the virtual space 11.

In at least one aspect, the virtual camera 14 includes two virtual cameras, that is, a virtual camera for providing a right-eye image and a virtual camera for providing a left-eye image. An appropriate parallax is set for the two virtual cameras so that the user 5 is able to recognize the three-dimensional virtual space 11. In at least one aspect, the virtual camera 14 is implemented by a single virtual camera. In this case, a right-eye image and a left-eye image may be generated from an image acquired by the single virtual camera. In at least one embodiment, the virtual camera 14 is assumed to include two virtual cameras, and the roll axes of the two virtual cameras are synthesized so that the generated roll axis (w) is adapted to the roll axis (w) of the HMD 120.

[Controller]

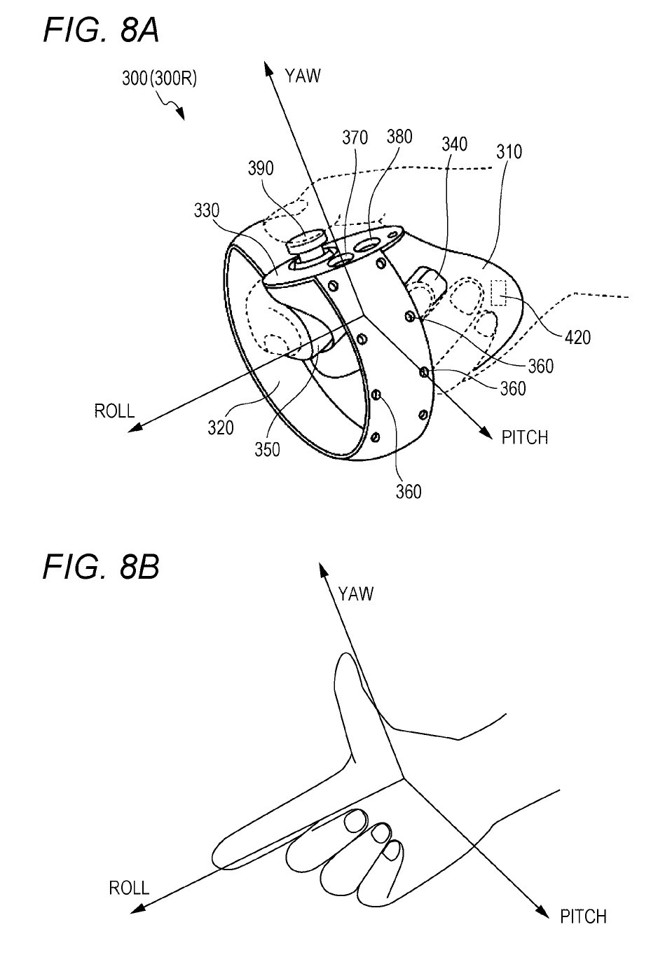

An example of the controller 300 is described with reference to FIG. 8A and FIG. 8B. FIG. 8A is a diagram of a schematic configuration of a controller according to at least one embodiment of this disclosure. FIG. 8B is a diagram of a coordinate system to be set for a hand of a user holding the controller according to at least one embodiment of this disclosure.

In at least one aspect, the controller 300 includes a right controller 300R and a left controller (not shown). In FIG. 8A only right controller 300R is shown for the sake of clarity. The right controller 300R is operable by the right hand of the user 5. The left controller is operable by the left hand of the user 5. In at least one aspect, the right controller 300R and the left controller are symmetrically configured as separate devices. Therefore, the user 5 can freely move his or her right hand holding the right controller 300R and his or her left hand holding the left controller. In at least one aspect, the controller 300 may be an integrated controller configured to receive an operation performed by both the right and left hands of the user 5. The right controller 300R is now described.

The right controller 300R includes a grip 310, a frame 320, and a top surface 330. The grip 310 is configured so as to be held by the right hand of the user 5. For example, the grip 310 may be held by the palm and three fingers (e.g., middle finger, ring finger, and small finger) of the right hand of the user 5.

The grip 310 includes buttons 340 and 350 and the motion sensor 420. The button 340 is arranged on a side surface of the grip 310, and receives an operation performed by, for example, the middle finger of the right hand. The button 350 is arranged on a front surface of the grip 310, and receives an operation performed by, for example, the index finger of the right hand. In at least one aspect, the buttons 340 and 350 are configured as trigger type buttons. The motion sensor 420 is built into the casing of the grip 310. When a motion of the user 5 can be detected from the surroundings of the user 5 by a camera or other device. In at least one embodiment, the grip 310 does not include the motion sensor 420.

The frame 320 includes a plurality of infrared LEDs 360 arranged in a circumferential direction of the frame 320. The infrared LEDs 360 emit, during execution of a program using the controller 300, infrared rays in accordance with progress of the program. The infrared rays emitted from the infrared LEDs 360 are usable to independently detect the position and the posture (inclination and direction) of each of the right controller 300R and the left controller. In FIG. 8A, the infrared LEDs 360 are shown as being arranged in two rows, but the number of arrangement rows is not limited to that illustrated in FIG. 8. In at least one embodiment, the infrared LEDs 360 are arranged in one row or in three or more rows. In at least one embodiment, the infrared LEDs 360 are arranged in a pattern other than rows.

The top surface 330 includes buttons 370 and 380 and an analog stick 390. The buttons 370 and 380 are configured as push type buttons. The buttons 370 and 380 receive an operation performed by the thumb of the right hand of the user 5. In at least one aspect, the analog stick 390 receives an operation performed in any direction of 360 degrees from an initial position (neutral position). The operation includes, for example, an operation for moving an object arranged in the virtual space 11.

In at least one aspect, each of the right controller 300R and the left controller includes a battery for driving the infrared ray LEDs 360 and other members. The battery includes, for example, a rechargeable battery, a button battery, a dry battery, but the battery is not limited thereto. In at least one aspect, the right controller 300R and the left controller are connectable to, for example, a USB interface of the computer 200. In at least one embodiment, the right controller 300R and the left controller do not include a battery.

In FIG. 8A and FIG. 8B, for example, a yaw direction, a roll direction, and a pitch direction are defined with respect to the right hand of the user 5. A direction of an extended thumb is defined as the yaw direction, a direction of an extended index finger is defined as the roll direction, and a direction perpendicular to a plane is defined as the pitch direction.

[Hardware Configuration of Server]

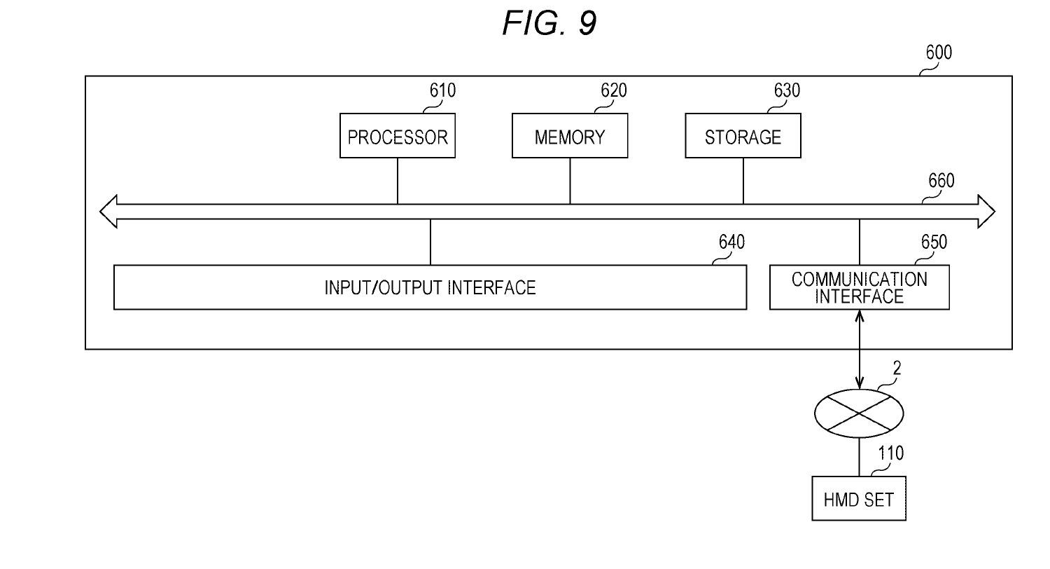

With reference to FIG. 9, the server 600 in at least one embodiment is described. FIG. 9 is a block diagram of a hardware configuration of the server 600 according to at least one embodiment of this disclosure. The server 600 includes a processor 610, a memory 620, a storage 630, an input/output interface 640, and a communication interface 650. Each component is connected to a bus 660. In at least one embodiment, at least one of the processor 610, the memory 620, the storage 630, the input/output interface 640 or the communication interface 650 is part of a separate structure and communicates with other components of server 600 through a communication path other than the bus 660.

The processor 610 executes a series of commands included in a program stored in the memory 620 or the storage 630 based on a signal transmitted to the server 600 or on satisfaction of a condition determined in advance. In at least one aspect, the processor 610 is implemented as a central processing unit (CPU), a graphics processing unit (GPU), a micro processing unit (MPU), a field-programmable gate array (FPGA), or other devices.

The memory 620 temporarily stores programs and data. The programs are loaded from, for example, the storage 630. The data includes data input to the server 600 and data generated by the processor 610. In at least one aspect, the memory 620 is implemented as a random access memory (RAM) or other volatile memories.

The storage 630 permanently stores programs and data. In at least one embodiment, the storage 630 stores programs and data for a period of time longer than the memory 620, but not permanently. The storage 630 is implemented as, for example, a read-only memory (ROM), a hard disk device, a flash memory, or other non-volatile storage devices. The programs stored in the storage 630 include programs for providing a virtual space in the system 100, simulation programs, game programs, user authentication programs, and programs for implementing communication to/from other computers 200 or servers 600. The data stored in the storage 630 may include, for example, data and objects for defining the virtual space.

In at least one aspect, the storage 630 is implemented as a removable storage device like a memory card. In at least one aspect, a configuration that uses programs and data stored in an external storage device is used instead of the storage 630 built into the server 600. With such a configuration, for example, in a situation in which a plurality of HMD systems 100 are used, for example, as in an amusement facility, the programs and the data are collectively updated.

The input/output interface 640 allows communication of signals to/from an input/output device. In at least one aspect, the input/output interface 640 is implemented with use of a USB, a DVI, an HDMI, or other terminals. The input/output interface 640 is not limited to the specific examples described above.

The communication interface 650 is connected to the network 2 to communicate to/from the computer 200 connected to the network 2. In at least one aspect, the communication interface 650 is implemented as, for example, a LAN, other wired communication interfaces, Wi-Fi, Bluetooth, NFC, or other wireless communication interfaces. The communication interface 650 is not limited to the specific examples described above.

In at least one aspect, the processor 610 accesses the storage 630 and loads one or more programs stored in the storage 630 to the memory 620 to execute a series of commands included in the program. In at least one embodiment, the one or more programs include, for example, an operating system of the server 600, an application program for providing a virtual space, and game software that can be executed in the virtual space. In at least one embodiment, the processor 610 transmits a signal for providing a virtual space to the HMD device 110 to the computer 200 via the input/output interface 640.

[Control Device of HMD]

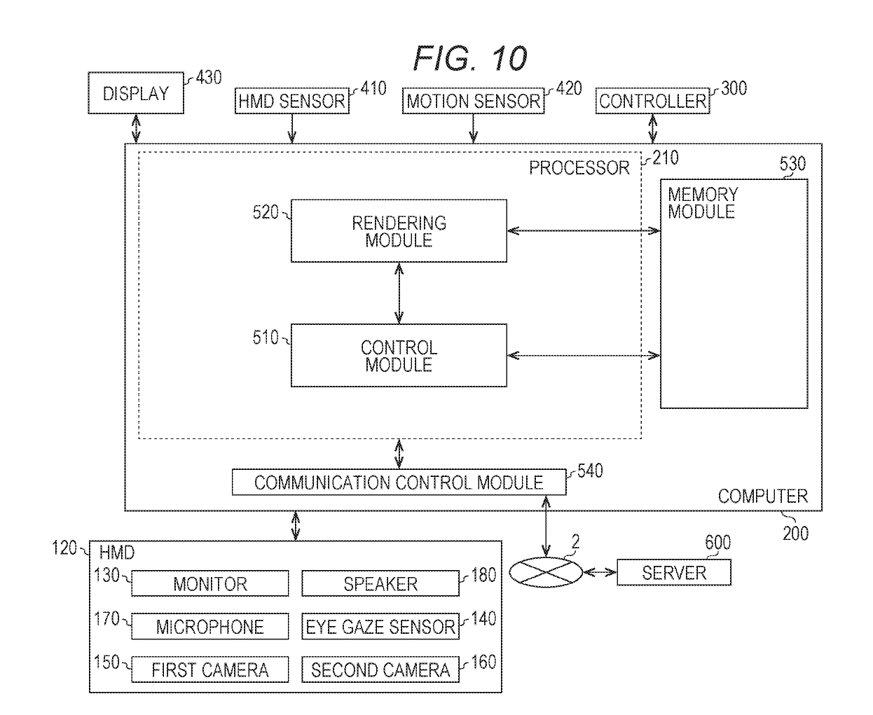

With reference to FIG. 10, the control device of the HMD 120 is described. According to at least one embodiment of this disclosure, the control device is implemented by the computer 200 having a known configuration. FIG. 10 is a block diagram of the computer 200 according to at least one embodiment of this disclosure. FIG. 10 includes a module configuration of the computer 200.

In FIG. 10, the computer 200 includes a control module 510, a rendering module 520, a memory module 530, and a communication control module 540. In at least one aspect, the control module 510 and the rendering module 520 are implemented by the processor 210. In at least one aspect, a plurality of processors 210 function as the control module 510 and the rendering module 520. The memory module 530 is implemented by the memory 220 or the storage 230. The communication control module 540 is implemented by the communication interface 250.

The control module 510 controls the virtual space 11 provided to the user 5. The control module 510 defines the virtual space 11 in the HMD system 100 using virtual space data representing the virtual space 11. The virtual space data is stored in, for example, the memory module 530. In at least one embodiment, the control module 510 generates virtual space data. In at least one embodiment, the control module 510 acquires virtual space data from, for example, the server 600. The control module 510 arranges objects in the virtual space 11 using object data representing objects. The object data is stored in, for example, the memory module 530. In at least one embodiment, the control module 510 generates virtual space data. In at least one embodiment, the control module 510 acquires virtual space data from, for example, the server 600. In at least one embodiment, the objects include, for example, an avatar object of the user 5, character objects, operation objects, for example, a virtual hand to be operated by the controller 300, and forests, mountains, other landscapes, streetscapes, or animals to be arranged in accordance with the progression of the story of the game.

The control module 510 arranges an avatar object of the user 5 of another computer 200, which is connected via the network 2, in the virtual space 11. In at least one aspect, the control module 510 arranges an avatar object of the user 5 in the virtual space 11. In at least one aspect, the control module 510 arranges an avatar object simulating the user 5 in the virtual space 11 based on an image including the user 5. In at least one aspect, the control module 510 arranges an avatar object in the virtual space 11, which is selected by the user 5 from among a plurality of types of avatar objects (e.g., objects simulating animals or objects of deformed humans).

The control module 510 identifies an inclination of the HMD 120 based on output of the HMD sensor 410. In at least one aspect, the control module 510 identifies an inclination of the HMD 120 based on output of the sensor 190 functioning as a motion sensor. The control module 510 detects parts (e.g., mouth, eyes, and eyebrows) forming the face of the user 5 from a face image of the user 5 generated by the first camera 150 and the second camera 160. The control module 510 detects a motion (shape) of each detected part.

The control module 510 detects a line of sight of the user 5 in the virtual space 11 based on a signal from the eye gaze sensor 140. The control module 510 detects a point-of-view position (coordinate values in the XYZ coordinate system) at which the detected line of sight of the user 5 and the celestial sphere of the virtual space 11 intersect with each other. More specifically, the control module 510 detects the point-of-view position based on the line of sight of the user 5 defined in the uvw coordinate system and the position and the inclination of the virtual camera 14. The control module 510 transmits the detected point-of-view position to the server 600. In at least one aspect, the control module 510 is configured to transmit line-of-sight information representing the line of sight of the user 5 to the server 600. In such a case, the control module 510 may calculate the point-of-view position based on the line-of-sight information received by the server 600.

The control module 510 translates a motion of the HMD 120, which is detected by the HMD sensor 410, in an avatar object. For example, the control module 510 detects inclination of the HMD 120, and arranges the avatar object in an inclined manner. The control module 510 translates the detected motion of face parts in a face of the avatar object arranged in the virtual space 11. The control module 510 receives line-of-sight information of another user 5 from the server 600, and translates the line-of-sight information in the line of sight of the avatar object of another user 5. In at least one aspect, the control module 510 translates a motion of the controller 300 in an avatar object and an operation object. In this case, the controller 300 includes, for example, a motion sensor, an acceleration sensor, or a plurality of light emitting elements (e.g., infrared LEDs) for detecting a motion of the controller 300.

The control module 510 arranges, in the virtual space 11, an operation object for receiving an operation by the user 5 in the virtual space 11. The user 5 operates the operation object to, for example, operate an object arranged in the virtual space 11. In at least one aspect, the operation object includes, for example, a hand object serving as a virtual hand corresponding to a hand of the user 5. In at least one aspect, the control module 510 moves the hand object in the virtual space 11 so that the hand object moves in association with a motion of the hand of the user 5 in the real space based on output of the motion sensor 420. In at least one aspect, the operation object may correspond to a hand part of an avatar object.

When one object arranged in the virtual space 11 collides with another object, the control module 510 detects the collision. The control module 510 is able to detect, for example, a timing at which a collision area of one object and a collision area of another object have touched with each other, and performs predetermined processing in response to the detected timing. In at least one embodiment, the control module 510 detects a timing at which an object and another object, which have been in contact with each other, have moved away from each other, and performs predetermined processing in response to the detected timing. In at least one embodiment, the control module 510 detects a state in which an object and another object are in contact with each other. For example, when an operation object touches another object, the control module 510 detects the fact that the operation object has touched the other object, and performs predetermined processing.

In at least one aspect, the control module 510 controls image display of the HMD 120 on the monitor 130. For example, the control module 510 arranges the virtual camera 14 in the virtual space 11. The control module 510 controls the position of the virtual camera 14 and the inclination (direction) of the virtual camera 14 in the virtual space 11. The control module 510 defines the field-of-view region 15 depending on an inclination of the head of the user 5 wearing the HMD 120 and the position of the virtual camera 14. The rendering module 520 generates the field-of-view region 17 to be displayed on the monitor 130 based on the determined field-of-view region 15. The communication control module 540 outputs the field-of-view region 17 generated by the rendering module 520 to the HMD 120.

The control module 510, which has detected an utterance of the user 5 using the microphone 170 from the HMD 120, identifies the computer 200 to which voice data corresponding to the utterance is to be transmitted. The voice data is transmitted to the computer 200 identified by the control module 510. The control module 510, which has received voice data from the computer 200 of another user via the network 2, outputs audio information (utterances) corresponding to the voice data from the speaker 180.

The memory module 530 holds data to be used to provide the virtual space 11 to the user 5 by the computer 200. In at least one aspect, the memory module 530 stores space information, object information, and user information.

The space information stores one or more templates defined to provide the virtual space 11.

The object information stores a plurality of panorama images 13 forming the virtual space 11 and object data for arranging objects in the virtual space 11. In at least one embodiment, the panorama image 13 contains a still image and/or a moving image. In at least one embodiment, the panorama image 13 contains an image in a non-real space and/or an image in the real space. An example of the image in a non-real space is an image generated by computer graphics.

The user information stores a user ID for identifying the user 5. The user ID is, for example, an internet protocol (IP) address or a media access control (MAC) address set to the computer 200 used by the user. In at least one aspect, the user ID is set by the user. The user information stores, for example, a program for causing the computer 200 to function as the control device of the HMD system 100.

The data and programs stored in the memory module 530 are input by the user 5 of the HMD 120. Alternatively, the processor 210 downloads the programs or data from a computer (e.g., server 600) that is managed by a business operator providing the content, and stores the downloaded programs or data in the memory module 530.

In at least one embodiment, the communication control module 540 communicates to/from the server 600 or other information communication devices via the network 2.

In at least one aspect, the control module 510 and the rendering module 520 are implemented with use of, for example, Unity® provided by Unity Technologies. In at least one aspect, the control module 510 and the rendering module 520 are implemented by combining the circuit elements for implementing each step of processing.

The processing performed in the computer 200 is implemented by hardware and software executed by the processor 410. In at least one embodiment, the software is stored in advance on a hard disk or other memory module 530. In at least one embodiment, the software is stored on a CD-ROM or other computer-readable non-volatile data recording media, and distributed as a program product. In at least one embodiment, the software may is provided as a program product that is downloadable by an information provider connected to the Internet or other networks. Such software is read from the data recording medium by an optical disc drive device or other data reading devices, or is downloaded from the server 600 or other computers via the communication control module 540 and then temporarily stored in a storage module. The software is read from the storage module by the processor 210, and is stored in a RAM in a format of an executable program. The processor 210 executes the program.

[Control Structure of HMD System]

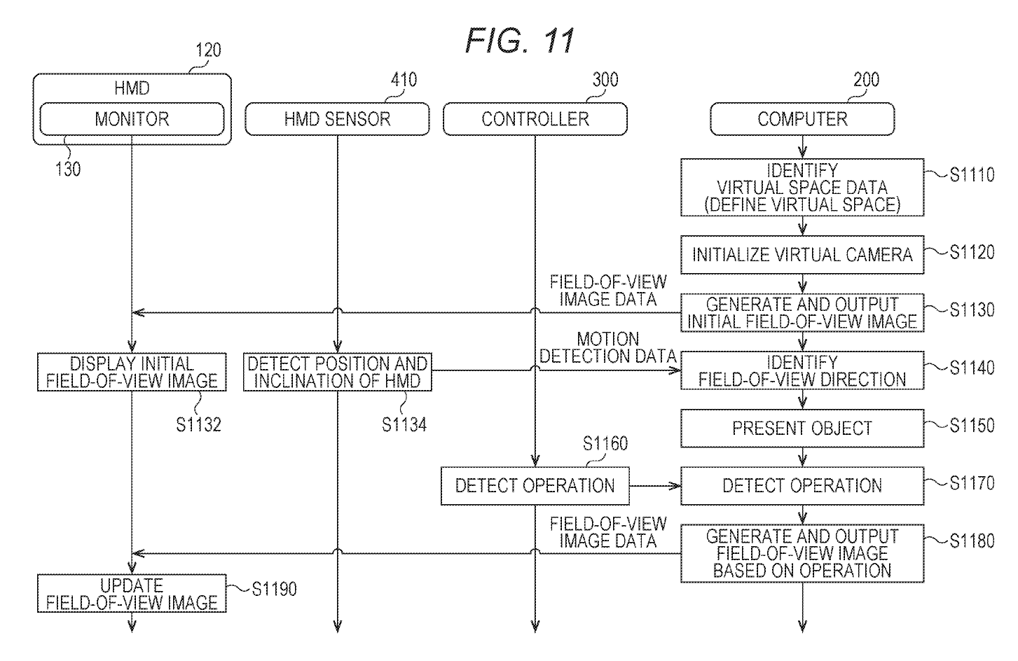

With reference to FIG. 11, the control structure of the HMD set 110 is described. FIG. 11 is a sequence chart of processing to be executed by the system 100 according to at least one embodiment of this disclosure.

In FIG. 11, in Step S1110, the processor 210 of the computer 200 serves as the control module 510 to identify virtual space data and define the virtual space 11.

In Step S1120, the processor 210 initializes the virtual camera 14. For example, in a work area of the memory, the processor 210 arranges the virtual camera 14 at the center 12 defined in advance in the virtual space 11, and matches the line of sight of the virtual camera 14 with the direction in which the user 5 faces.

In Step S1130, the processor 210 serves as the rendering module 520 to generate field-of-view image data for displaying an initial field-of-view image. The generated field-of-view image data is output to the HMD 120 by the communication control module 540.

In Step S1132, the monitor 130 of the HMD 120 displays the field-of-view image based on the field-of-view image data received from the computer 200. The user 5 wearing the HMD 120 is able to recognize the virtual space 11 through visual recognition of the field-of-view image.

In Step S1134, the HMD sensor 410 detects the position and the inclination of the HMD 120 based on a plurality of infrared rays emitted from the HMD 120. The detection results are output to the computer 200 as motion detection data.

In Step S1140, the processor 210 identifies a field-of-view direction of the user 5 wearing the HMD 120 based on the position and inclination contained in the motion detection data of the HMD 120.

In Step S1150, the processor 210 executes an application program, and arranges an object in the virtual space 11 based on a command contained in the application program.

In Step S1160, the controller 300 detects an operation by the user 5 based on a signal output from the motion sensor 420, and outputs detection data representing the detected operation to the computer 200. In at least one aspect, an operation of the controller 300 by the user 5 is detected based on an image from a camera arranged around the user 5.

In Step S1170, the processor 210 detects an operation of the controller 300 by the user 5 based on the detection data acquired from the controller 300.

In Step S1180, the processor 210 generates field-of-view image data based on the operation of the controller 300 by the user 5. The communication control module 540 outputs the generated field-of-view image data to the HMD 120.

In Step S1190, the HMD 120 updates a field-of-view image based on the received field-of-view image data, and displays the updated field-of-view image on the monitor 130.

[Avatar Object]

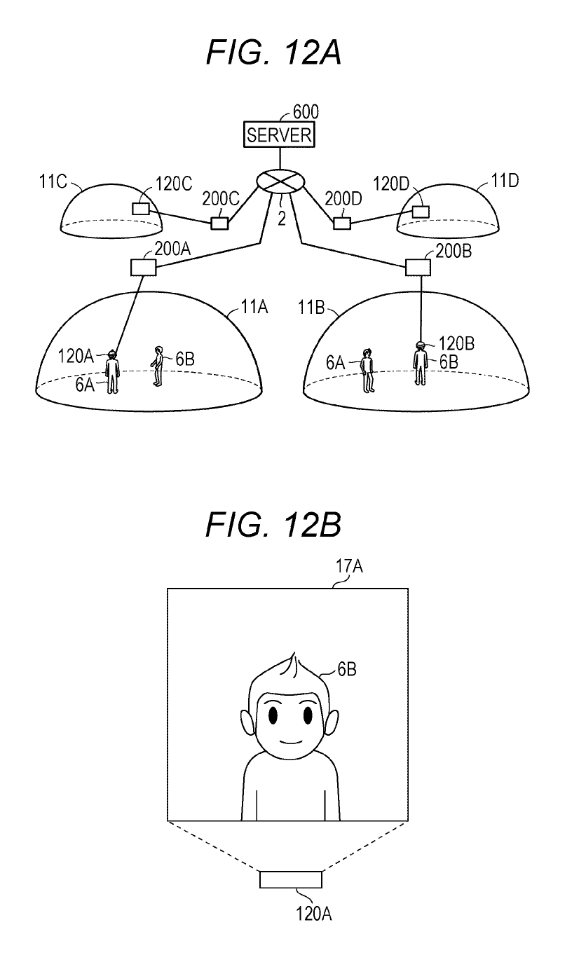

With reference to FIG. 12A and FIG. 12B, an avatar object according to at least one embodiment is described. FIG. 12 and FIG. 12B are diagrams of avatar objects of respective users 5 of the HMD sets 110A and 110B. In the following, the user of the HMD set 110A, the user of the HMD set 110B, the user of the HMD set 110C, and the user of the HMD set 110D are referred to as “user 5A”, “user 5B”, “user 5C”, and “user 5D”, respectively. A reference numeral of each component related to the HMD set 110A, a reference numeral of each component related to the HMD set 110B, a reference numeral of each component related to the HMD set 110C, and a reference numeral of each component related to the HMD set 110D are appended by A, B, C, and D, respectively. For example, the HMD 120A is included in the HMD set 110A.

FIG. 12A is a schematic diagram of HMD systems of several users sharing the virtual space interact using a network according to at least one embodiment of this disclosure. Each HMD 120 provides the user 5 with the virtual space 11. Computers 200A to 200D provide the users 5A to 5D with virtual spaces 11A to 11D via HMDs 120A to 120D, respectively. In FIG. 12A, the virtual space 11A and the virtual space 11B are formed by the same data. In other words, the computer 200A and the computer 200B share the same virtual space. An avatar object 6A of the user 5A and an avatar object 6B of the user 5B are present in the virtual space 11A and the virtual space 11B. The avatar object 6A in the virtual space 11A and the avatar object 6B in the virtual space 11B each wear the HMD 120. However, the inclusion of the HMD 120A and HMD 120B is only for the sake of simplicity of description, and the avatars do not wear the HMD 120A and HMD 120B in the virtual spaces 11A and 11B, respectively.

In at least one aspect, the processor 210A arranges a virtual camera 14A for photographing a field-of-view region 17A of the user 5A at the position of eyes of the avatar object 6A.

FIG. 12B is a diagram of a field of view of a HMD according to at least one embodiment of this disclosure. FIG. 12(B) corresponds to the field-of-view region 17A of the user 5A in FIG. 12A. The field-of-view region 17A is an image displayed on a monitor 130A of the HMD 120A. This field-of-view region 17A is an image generated by the virtual camera 14A. The avatar object 6B of the user 5B is displayed in the field-of-view region 17A. Although not included in FIG. 12B, the avatar object 6A of the user 5A is displayed in the field-of-view image of the user 5B.

In the arrangement in FIG. 12B, the user 5A can communicate to/from the user 5B via the virtual space 11A through conversation. More specifically, voices of the user 5A acquired by a microphone 170A are transmitted to the HMD 120B of the user 5B via the server 600 and output from a speaker 180B provided on the HMD 120B. Voices of the user 5B are transmitted to the HMD 120A of the user 5A via the server 600, and output from a speaker 180A provided on the HMD 120A.

The processor 210A translates an operation by the user 5B (operation of HMD 120B and operation of controller 300B) in the avatar object 6B arranged in the virtual space 11A. With this, the user 5A is able to recognize the operation by the user 5B through the avatar object 6B.

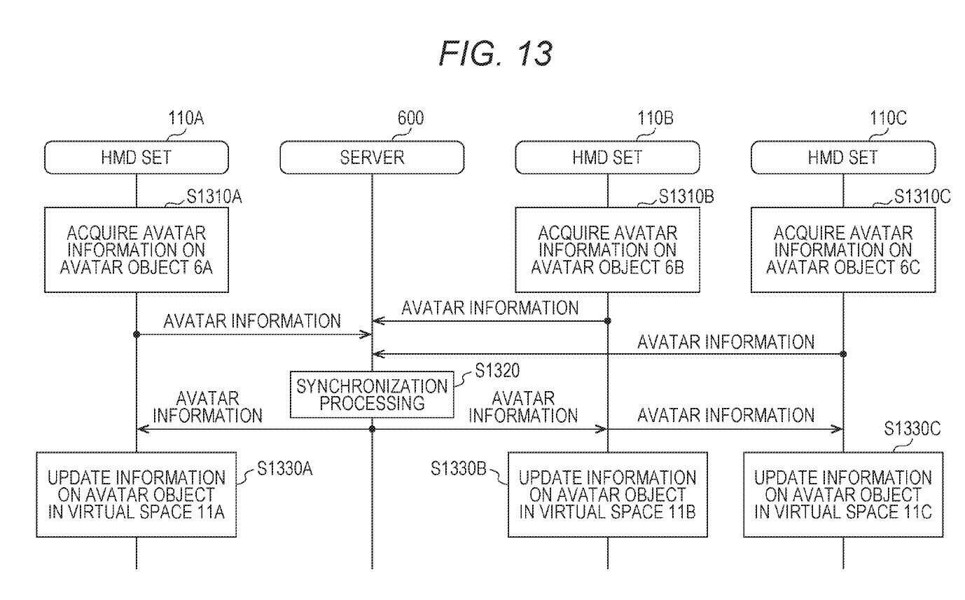

FIG. 13 is a sequence chart of processing to be executed by the system 100 according to at least one embodiment of this disclosure. In FIG. 13, although the HMD set 110D is not included, the HMD set 110D operates in a similar manner as the HMD sets 110A, 110B, and 110C. Also in the following description, a reference numeral of each component related to the HMD set 110A, a reference numeral of each component related to the HMD set 110B, a reference numeral of each component related to the HMD set 110C, and a reference numeral of each component related to the HMD set 110D are appended by A, B, C, and D, respectively.

In Step S1310A, the processor 210A of the HMD set 110A acquires avatar information for determining a motion of the avatar object 6A in the virtual space 11A. This avatar information contains information on an avatar such as motion information, face tracking data, and sound data. The motion information contains, for example, information on a temporal change in position and inclination of the HMD 120A and information on a motion of the hand of the user 5A, which is detected by, for example, a motion sensor 420A. An example of the face tracking data is data identifying the position and size of each part of the face of the user 5A. Another example of the face tracking data is data representing motions of parts forming the face of the user 5A and line-of-sight data. An example of the sound data is data representing sounds of the user 5A acquired by the microphone 170A of the HMD 120A. In at least one embodiment, the avatar information contains information identifying the avatar object 6A or the user 5A associated with the avatar object 6A or information identifying the virtual space 11A accommodating the avatar object 6A. An example of the information identifying the avatar object 6A or the user 5A is a user ID. An example of the information identifying the virtual space 11A accommodating the avatar object 6A is a room ID. The processor 210A transmits the avatar information acquired as described above to the server 600 via the network 2.

In Step S1310B, the processor 210B of the HMD set 110B acquires avatar information for determining a motion of the avatar object 6B in the virtual space 11B, and transmits the avatar information to the server 600, similarly to the processing of Step S1310A. Similarly, in Step S1310C, the processor 210C of the HMD set 110C acquires avatar information for determining a motion of the avatar object 6C in the virtual space 11C, and transmits the avatar information to the server 600.

In Step S1320, the server 600 temporarily stores pieces of player information received from the HMD set 110A, the HMD set 110B, and the HMD set 110C, respectively. The server 600 integrates pieces of avatar information of all the users (in this example, users 5A to 5C) associated with the common virtual space 11 based on, for example, the user IDs and room IDs contained in respective pieces of avatar information. Then, the server 600 transmits the integrated pieces of avatar information to all the users associated with the virtual space 11 at a timing determined in advance. In this manner, synchronization processing is executed. Such synchronization processing enables the HMD set 110A, the HMD set 110B, and the HMD 120C to share mutual avatar information at substantially the same timing.

Next, the HMD sets 110A to 110C execute processing of Step S1330A to Step S1330C, respectively, based on the integrated pieces of avatar information transmitted from the server 600 to the HMD sets 110A to 110C. The processing of Step S1330A corresponds to the processing of Step S1180 of FIG. 11.

In Step S1330A, the processor 210A of the HMD set 110A updates information on the avatar object 6B and the avatar object 6C of the other users 5B and 5C in the virtual space 11A. Specifically, the processor 210A updates, for example, the position and direction of the avatar object 6B in the virtual space 11 based on motion information contained in the avatar information transmitted from the HMD set 110B. For example, the processor 210A updates the information (e.g., position and direction) on the avatar object 6B contained in the object information stored in the memory module 530. Similarly, the processor 210A updates the information (e.g., position and direction) on the avatar object 6C in the virtual space 11 based on motion information contained in the avatar information transmitted from the HMD set 110C.

In Step S1330B, similarly to the processing of Step S1330A, the processor 210B of the HMD set 110B updates information on the avatar object 6A and the avatar object 6C of the users 5A and 5C in the virtual space 11B. Similarly, in Step S1330C, the processor 210C of the HMD set 110C updates information on the avatar object 6A and the avatar object 6B of the users 5A and 5B in the virtual space 11C.

[Details of Module Configuration]

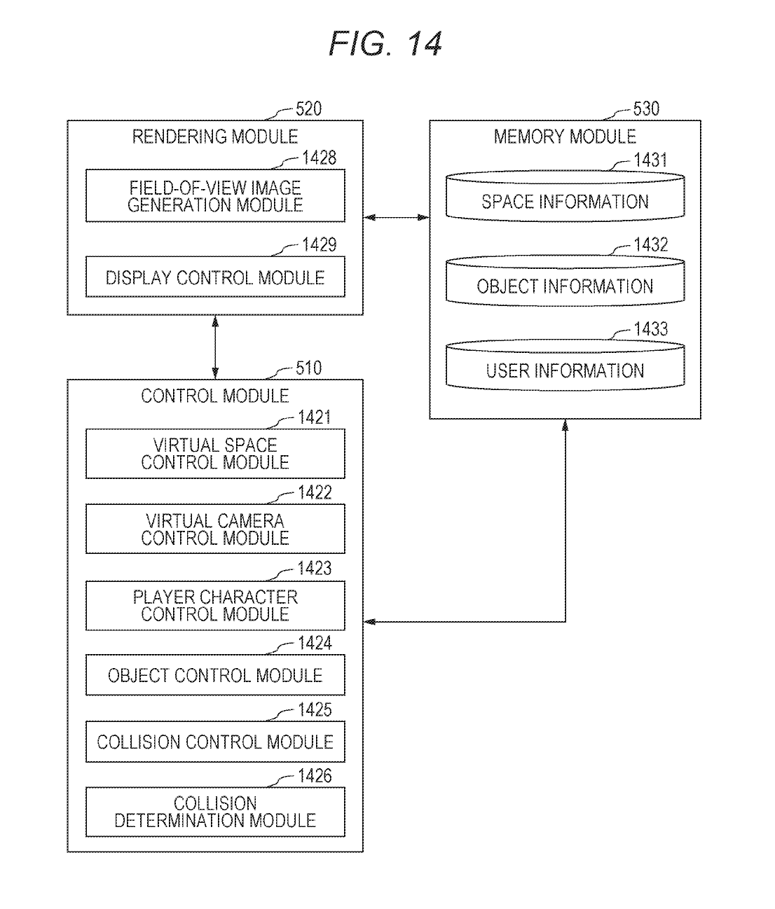

With reference to FIG. 14, details of a module configuration of the computer 200 are described. FIG. 14 is a block diagram of a configuration of modules of the computer according to at least one embodiment of this disclosure.

In FIG. 14, the control module 510 includes a virtual space control module 1421, a virtual camera control module 1422, a player character control module 1423, an object control module 1424, a collision control module 1425, and a collision determination module 1426. The rendering module 520 includes a field-of-view image generation module 1428, and a display control module 1429. The memory module 530 stores space information 1431, object information 1432, and user information 1433.

The virtual space control module 1421 controls the virtual space 11 provided to the user 5. In at least one embodiment, the virtual space control module 1421 defines the virtual space 11 in the HMD system 100 by identifying the virtual space data representing the virtual space 11. In at least one embodiment, as an example, there is described a case in which virtual space elements, such as the virtual camera 14, various objects, and a background image, are arranged in the virtual space 11 by modules other than the virtual space control module 1421. However, this disclosure is not limited thereto, and the arrangement of the virtual space elements may be performed by the virtual space control module 1421. The arrangement of the virtual space elements in the virtual space 11 may be performed for the whole virtual space 11, or may be limited to the field-of-view region 15 determined by a virtual camera control module 1422 described later.

The virtual camera control module 1422 arranges the virtual camera 14 in the virtual space 11 and controls the motion of the virtual camera 14 in the virtual space 11. In at least one embodiment, the virtual camera control module 1422 controls the behavior, direction, and the like of the virtual camera 14 in the virtual space 11 based on the direction (motion of HMD 120) of the head of the user wearing the HMD 120, a key operation of the controller 300 (operation of buttons 370 and 380 and analog stick 390) by the user. More specifically, the field-of-view region 15 of the virtual camera 14 is defined based on the direction of the head of the user wearing the HMD 120 and the key operation of the controller 300 (operation of buttons 370 and 380 and analog stick 390) by the user. However, the motion control of the virtual camera 14 is not limited thereto.

The player character control module 1423 arranges the virtual camera 14 in the virtual space 11 and controls the motion (e.g., movement or state change) of the player character in the virtual space 11. The player character is a character object associated with the user wearing the HMD 120, and may be the player character itself or an object forming a portion of the player character. The player character may also be referred to as the avatar object 6. Examples of the objects forming a portion of the player character include, but are not limited to, ahead object, a hand object (virtual hand), a finger object (virtual finger), and the like.

In at least one embodiment, as an example, there is described a case in which the player character is formed of the head object of the player character and the hand object of the player character, but this disclosure is not limited thereto. In at least one embodiment, the head object of the player character corresponds to the head of the user wearing the HMD 120, and is associated with the virtual camera 14. Therefore, the player character control module 1423 moves the head object of the player character in association with the motion control of the virtual camera 14 by the virtual camera control module 1422. For example, when the player character is in a first-person perspective, the player character control module 1423 associates, at the same position as the virtual camera 14, the motion of the head object of the player character with the motion of the virtual camera 14.

In at least one embodiment, the hand object of the player character corresponds to a hand of the user wearing the HMD 120. Therefore, the player character control module 1423 moves the hand object of the player character based on the motion of the controller 300 held by the user in his or her hand and the key operation of the controller 300 (operation of buttons 370 and 380 and analog stick 390) by the user. The hand object may become an operation object for operating an object arranged in the virtual space 11. In place of the hand object, the operation object may be the finger object, a stick object corresponding to a stick used by the user, and the like. When the operation object is the finger object, in particular, the operation object corresponds to a portion of the axis in the direction (axis direction) indicated by the finger.

The object control module 1424 arranges in the virtual space 11 objects other than the player character, and controls the motion (e.g., movement or state change) in the virtual space 11 of the objects other than the player character. Examples of objects other than the player character include, but are not limited to, a target object, a background object, and the like. The target object may be, for example, an object (e.g., enemy character or wall object) that performs at least one of applying an influence on the player character and receiving an influence by the player character, and the like. However, the target object is not limited to such an example. The background object may be, for example, forests, mountains, other landscapes, or animals to be arranged in accordance with the progression of the story of the game. The object control module 1424 may control a still object while arranging the object at a fixed position.

The collision control module 1425 performs control of assigning, based on the information on the speed of the HMD 120, an element for applying an influence on collision determination between the player character and the target object. Examples of the information on the speed of the HMD 120 include, but are not limited to, information that may be identified from the motion of the HMD 120, such as the speed, velocity, and acceleration of the HMD 120. In at least one embodiment, as the control of assigning an element for applying an influence on the collision determination, the collision control module 1425 performs control of identifying (determining) the size of the head of the player character arranged in the virtual space 11 or the collision area associated with the virtual camera 14. Specifically, the collision control module 1425 identifies the size of the collision area at a time when the information on the speed of the HMD 120 is equal to or higher than the predetermined speed to be a size different from the size of the collision area at a time when the information on the speed of the HMD 120 is less than the predetermined speed. However, the control performed by the collision control module 1425 is not limited thereto.

The collision determination module 1426 determines a collision between the objects by determining a collision (contact) of the collision area between the objects. For example, the collision determination module 1426 may detect the timing at which an object touches another object, and when a collision is detected, performs processing determined in advance. The collision determination module 1426 may also detect the timing at which the objects, which have been in contact with each other, have separated from each other, and perform processing determined in advance when such a detection is made. In at least one embodiment, the collision determination module 1426 determines a collision between the player character and the target object based on the element assigned by the collision control module 1425 and the positional relationship between the target object and the head of the player character or the collision area associated with the virtual camera 14. Specifically, the collision determination module 1426 determines a collision between the player character and the target object based on the positional relationship between the target object and a collision area whose size has been identified by the collision control module 1425. However, the processing performed by the collision determination module 1426 is not limited thereto.

The field-of-view image generation module 1428 generates, based on the field-of-view region 15 determined by the virtual camera control module 1422, field-of-view image data to be displayed on the monitor 130. Specifically, the field-of-view image generation module 1428 generates the field-of-view image data based on the field of view of the virtual camera defined based on the motion of the virtual camera 14, the virtual space data identified by the virtual space control module 1421, and the collision determination result of the collision determination module 1426.

The display control module 1429 displays a field-of-view image on the monitor 130 of the HMD 120 based on the field-of-view image data generated by the field-of-view image generation module 1428. For example, the display control module 1429 displays a field-of-view image on the monitor 130 by outputting the field-of-view image data generated by the field-of-view image generation module 1428 to the HMD 120.

The space information 1431 includes, for example, one or more templates defined to provide the virtual space 11. The object information 1432 includes, for example, content to be played back in the virtual space 11, information for arranging the objects used in the content, attribute information such as rendering data of the player character and size information on the player character, and the like. The content may include, for example, game content and content representing landscapes that resemble those of the real society. The user information 1433 stores, for example, a program for causing the computer 200 to function as a control device of the system 100 and an application program that uses each piece of content stored in the object information 1432.

[Control Structure]

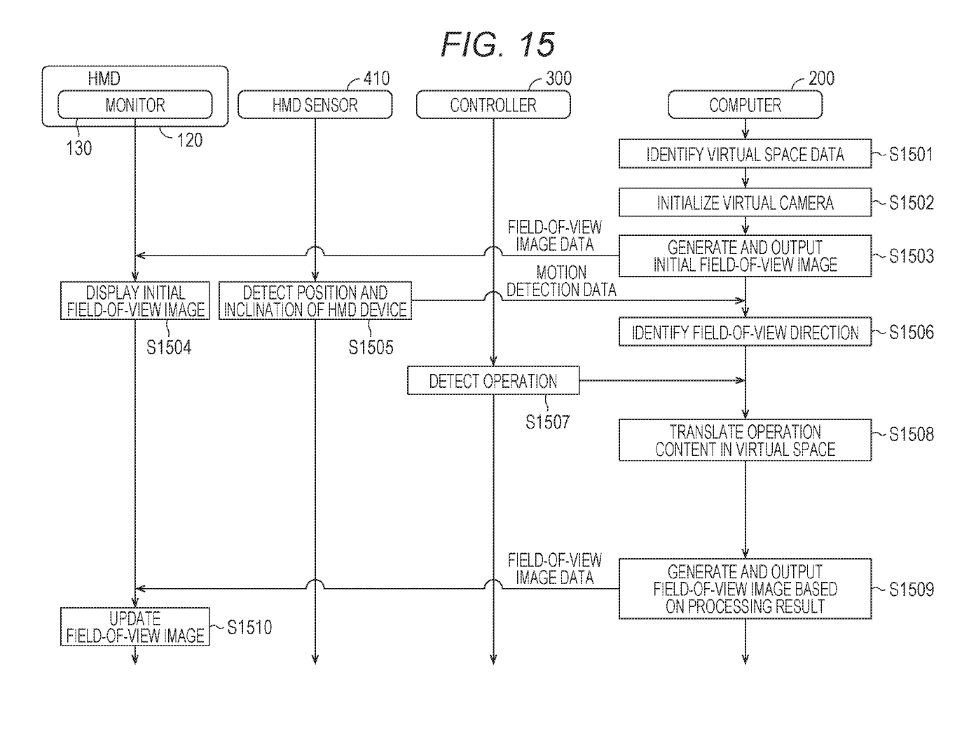

With reference to FIG. 15, the control structure of the computer 200 according to at least one embodiment of this disclosure is described. FIG. 15 is a flowchart of processing to be executed by the HMD system 100, which is used by the user 5, to provide the virtual space 11 to the user 5 according to at least one embodiment of this disclosure.

In Step S1501, the processor 210 of the computer 200 serves as the virtual space control module 1421 to identify the virtual space data and define the virtual space 11. The processor 210 serves as the player character control module 1423 and the object control module 1424 to arrange the player character and the objects other than the player character in the virtual space 11. The virtual space control module 1421 controllably defines the motion of those objects in the virtual space 11.

In Step S1502, the processor 210 serves as the virtual camera control module 1422 to initialize the virtual camera 14. For example, in a work area of the memory, the processor 210 arranges the virtual camera 14 at the center defined in advance in the virtual space 11, and matches the line of sight of the virtual camera 14 with the direction in which the user 5 faces.

In Step S1503, the processor 210 serves as the field-of-view image generation module 1428 to generate field-of-view image data for displaying the initial field-of-view image. The display control module 1429 transmits (outputs) the generated field-of-view image data to the HMD 120 via the communication control module 540.

In Step S1504, the monitor 130 of the HMD 120 displays a field-of-view image based on the field-of-view image data received from the computer 200. The user 5 wearing the HMD 120 may recognize the virtual space 11 through visual recognition of the field-of-view image.

In Step S1505, the HMD sensor 410 detects the position and inclination of the HMD 120 based on a plurality of infrared rays emitted from the HMD 120. The detection results are transmitted to the computer 200 as motion detection data.

In Step S1506, the processor 210 serves as the virtual camera control module 1422 to identify a field-of-view direction of the user 5 wearing the HMD 120 based on the position and inclination of the HMD 120.

In Step S1507, the controller 300 detects an operation performed by the user 5 in the real space. For example, in at least one aspect, the controller 300 detects that a button has been pressed by the user 5. In at least one aspect, the controller 300 detects a motion of a hand of the user 5 (e.g., sticking one hand forward). A signal indicating details of the detection is transmitted to the computer 200.

In Step S1508, the processor 210 serves as the player character control module 1423, the object control module 1424, the collision control module 1425, and the collision determination module 1426 to translate the motion detection data transmitted from the HMD sensor 410, the details of detection transmitted from the controller 300, and the details of control of the various objects in the virtual space 11.

For example, the processor 210 serves as the player character control module 1423 to move the player character (head object and hand object) in the virtual space 11 based on the motion detection data of the HMD 120 and the details of detection of the controller 300. For example, the processor 210 serves as the object control module 1424 to control the motion of an object other than the player character, for example, the target object. For example, the processor 210 serves as the collision control module 1425 to control the size of the collision area of the player character (specifically, head object) based on the speed of the HMD 120. For example, the processor 210 serves as the collision determination module 1426 to perform collision determination between a collision area of the player character (specifically, head object) and the collision area of the target object.

In Step S1509, the processor 210 serves as the field-of-view image generation module 1428 to generate field-of-view image data for displaying a field-of-view image based on the results of the processing in Step S1508. The display control module 1429 outputs the generated field-of-view image data to the HMD 120.

In Step S1510, the monitor 130 of the HMD 120 updates a field-of-view image based on the received field-of-view image data, and displays the updated field-of-view image.

### First Embodiment

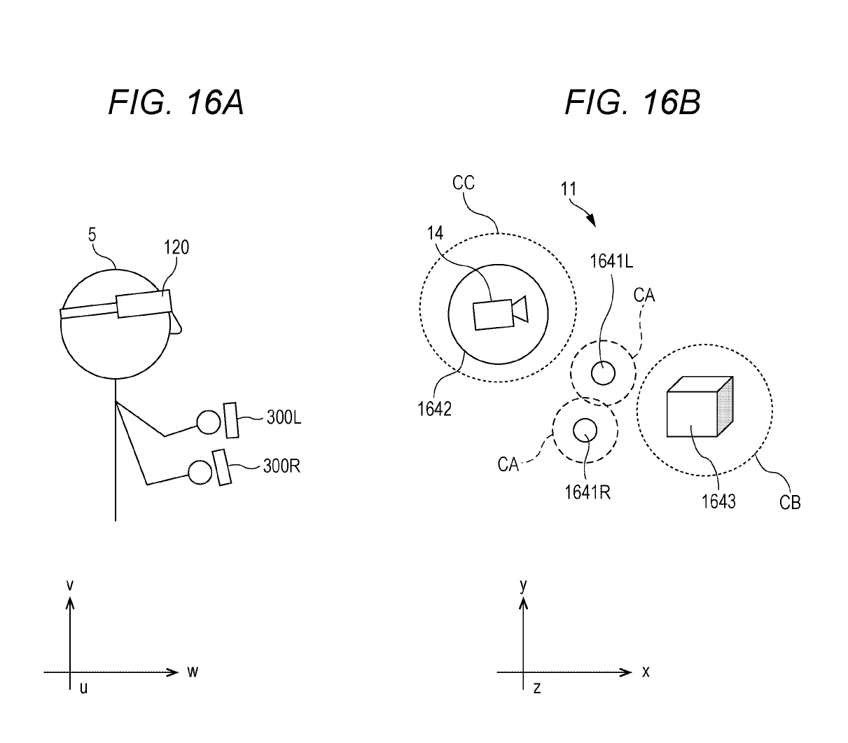

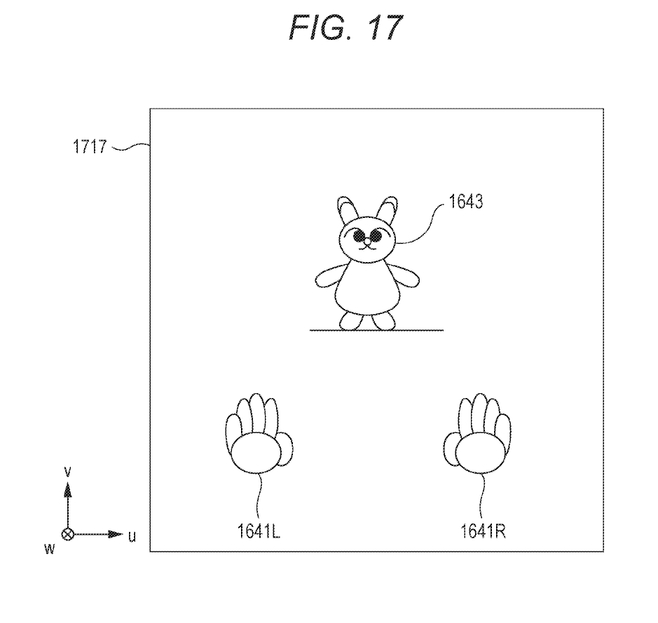

Next, the motion of the user 5 and the relationship between the virtual camera 14 and the various objects arranged in the virtual space 11 is described with reference to FIG. 16A, FIG. 16B, and FIG. 17. FIG. 16A is a diagram of an example of the user 5 wearing the HMD 120 and controllers 300L and 300R according to at least one embodiment of this disclosure. FIG. 16B is a diagram of the virtual camera 14, a head object 1642 of the player character, a left hand object 1641L of the player character, a right hand object 1641R of the player character, and an enemy character 1643 arranged in the virtual space 11 according to at least one embodiment of this disclosure. FIG. 17 is a diagram of an example of a field-of-view image 1717 obtained by photographing the virtual space 11 of FIG. 16B from the field-of-view region 15 of the virtual camera 14 according to at least one embodiment of this disclosure.

In a first embodiment of this disclosure, the virtual camera 14 moves in association with the motion of the HMD 120 worn by the user 5. Specifically, the visual field of the virtual camera 14 is updated in accordance with the motion of the HMD 120. In the first embodiment, the virtual camera 14 and the player character (more specifically, head object 1642 of player character) are associated with each other such that the position of the virtual camera 14 and the position of the player character match each other and the reference-line-of-sight 16 of the virtual camera 14 matches the line of sight of the player character. In the first embodiment, the left hand object 1641L is an operation object moving in accordance with the motion of the controller 300L worn on the left hand of the user 5 and the right hand object 1641R is an operation object moving in accordance with the motion of the controller 300R worn on the right hand of the user 5. In the following description, the left hand object 1641L and the right hand object 1641R may collectively be referred to simply as “hand object 1641”.

In the first embodiment, a collision area for determining a collision between objects is set for each object. In the example of FIG. 16A and FIG. 16B, a collision area CA is set for each of the left hand object 1641L and the right hand object 1641R, a collision area CB is set for the enemy character 1643, and a collision area CC is set for the head object 1642. In the first embodiment, as in FIG. 16A and FIG. 16B, there is described an example in which the collision area is set as a spherical shape with a diameter R centered around a center position of the object, but this disclosure is not limited thereto. For example, the collision area may be centered around a position other than the center position of the object, or may have a shape other than a spherical shape, such as an ellipse or a bar shape, or the size may be different for each object.

In the first embodiment, the collision area is used for collision determination (hit determination) between the player character and the enemy character 1643 in order to apply a predetermined influence on the player character and the enemy character 1643. Specifically, a predetermined influence is applied on the player character and the enemy character 1643 as a result of the collision areas of the player character and the enemy character 1643 colliding (contacting) each other due to an operation or motion of the user 5 (motion of HMD 120, or operation or motion of controller 300R and controller 300L) or movement of the enemy character 1643 based on a predetermined algorithm.

For example, the predetermined algorithm for controlling the movement of the enemy character 1643 moves the enemy character 1643 such that the collision area CC of the head object 1642 of the player character and the collision area CB of the enemy character 1643 collide with each other. In the first embodiment, when the processor 210 (collision determination module 1426) determines that the collision area CC of the head object 1642 of the player character and the collision area CB of the enemy character 1643 have collided, the processor 210 varies a first parameter associated with the player character. In the first embodiment, in this case, the processor 210 (collision determination module 1426) reduces the first parameter. However, this disclosure is not limited thereto, and the first parameter may be increased.

In the first embodiment, the user 5 moves the HMD 120 or moves the controller 300R and the controller 300L so as to avoid a reduction in the first parameter associated with the player character, that is, so as to avoid a collision between the collision area CC of the head object 1642 of the player character and the collision area CB of the enemy character 1643.

For example, the user 5 causes the collision area CA of the hand object 1641 of the player character and the collision area CB of the enemy character 1643 to collide by moving the controller 300R and the controller 300L such that the hand object 1641 hits the enemy character 1643. In the first embodiment, when the processor 210 (collision determination module 1426) determines that the collision area CA of the hand object 1641 of the player character and the collision area CB of the enemy character 1643 have collided, the processor 210 varies a second parameter associated with the enemy character 1643. In the first embodiment, in this case, the processor 210 (collision determination module 1426) reduces the second parameter. However, this disclosure is not limited thereto, and the second parameter may be increased.

In the first embodiment, the user 5 moves the HMD 120 or moves the controller 300R and the controller 300L so as to reduce the second parameter associated with the enemy character 1643, that is, so as to cause the collision area CA of the hand object 1641 of the player character and the collision area CB of the enemy character 1643 to collide with each other.

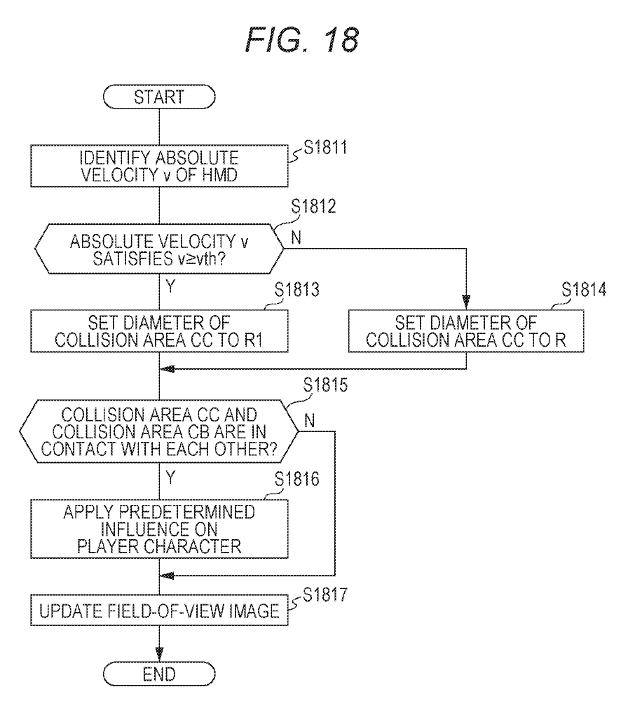

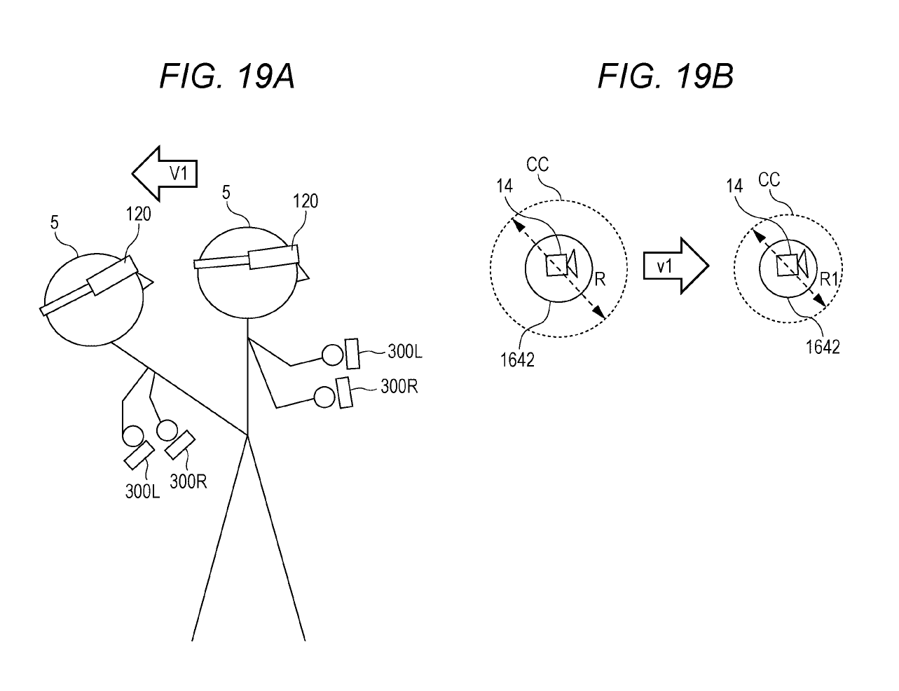

Next, an information processing method, specifically, a method of controlling the size of the collision area, according to the first embodiment of this disclosure is described with reference to FIG. 18, FIG. 19A, and FIG. 19B. FIG. 18 is a flowchart of an example of collision determination processing according to the first embodiment of this disclosure. The collision determination processing of FIG. 18 corresponds to an example of the detailed processing of Step S1508 to Step S1510 of the flowchart of FIG. 15. FIG. 19A is a diagram of an example of a state in which the user 5 has moved his or her head backward according to the first embodiment of this disclosure. FIG. 19B is a diagram of an example of control of the size of the collision area CC of the head object 1642 of the player character in the state of FIG. 19A according to at least one embodiment of this disclosure.

In the first embodiment, as described above, the user 5 moves the HMD 120 or moves the controller 300R and the controller 300L so as to avoid a collision between the collision area CC of the head object 1642 of the player character and the collision area CB of the enemy character 1643.

The user 5 is wearing the HMD 120 and is viewing the field-of-view image displayed on the monitor 130, and is hence enjoying an experience as if he or she is in the virtual space (immersed in the virtual space). Therefore, when the user 5 desires to avoid a collision between the collision area CC of the head object 1642 of the player character and the collision area CB of the enemy character 1643, the user 5 is considered to avoid a collision between the collision area CC of the head object 1642 of the player character and the collision area CB of the enemy character 1643 by moving his or her head. In this case, in order to improve the sense of immersion of the user 5 in the virtual space, it is preferred to avoid as much as possible a situation in which a collision between the collision area CC of the head object 1642 of the player character and the collision area CB of the enemy character 1643 has not been avoided even though the user 5 feels that he or she has avoided the collision (attack) by the enemy character 1643.

Therefore, in the first embodiment, the processor 210 (collision control module 1425) reduces the size of the collision area CC when the HMD 120 is moving at a predetermined speed or faster.

In FIG. 18, first, in Step S1811, the processor 210 identifies an absolute velocity v of the HMD 120. The absolute velocity v of the HMD 120 indicates the velocity of the HMD 120 observed from a fixed position in the real space. In the first embodiment, the absolute velocity v of the HMD 120 is described using an example in which the absolute velocity v is the velocity of the HMD 120 with respect to the HMD sensor 410 installed at a predetermined place in the physical space, but this disclosure is not limited thereto. In the first embodiment, the user 5 is wearing the HMD 120 on his or her head, and hence the absolute velocity of the head of the user 5 corresponds to the absolute velocity of the HMD 120.

Specifically, each time the processor 210 acquires information detected by the HMD sensor 410, the processor 210 identifies the position of the HMD 120 based on that information, and identifies the absolute velocity v in the movement direction of the HMD 120 based on the identified position information and position information that was identified the previous time. For example, when the position of the HMD 120 in an nth frame (n is an integer of 1 or more) is Pn, the position of the HMD 120 in the (n+1)th frame is Pn+1. When a time interval between frames is ΔT, an absolute velocity vn of the HMD 120 in the nth frame is vn=(position(Pn+1)-position Pn)/ΔT. ΔT is 1/frame rate. For example, when the frame rate is 90 fps (frames per second), ΔT= 1/90.

The module identifying the absolute velocity v of the HMD 120 may be, for example, the player character control module 1423, the virtual camera control module 1422, or the collision control module 1425.

Returning to FIG. 18, next, in Step S1812, the processor 210 (collision control module 1425) determines whether the absolute velocity v of the HMD 120 is equal to or more than a predetermined threshold velocity vth. The predetermined velocity vth may be appropriately set in accordance with the game content, or set by measuring in advance the velocity at which the head of the user 5 is moved.

When it is determined in Step S1812 that the absolute velocity v of the HMD 120 is equal to or more than the predetermined velocity vth (v≥vth) (Yes in Step S1812), the processor 210 (collision control module 1425) identifies (determines) that the diameter of the size of the collision area CC of the head object 1642 of the player character is R1 (R1<R) (Step S1813). For example, as in FIG. 19A, in order to avoid contact between the player character (head object 1642) and the enemy character 1643, when an absolute velocity v1 of the HMD 120 at a time when the user 5 moves his or her head backward is equal to or more than the predetermined velocity vth, as in FIG. 19B, the size of the collision area CC of the head object 1642 of the player character is set to a diameter R1, which is smaller than the diameter R.

On the other hand, when it is determined that the absolute velocity v of the HMD 120 is less than the predetermined velocity vth (v<vth) (No in Step S1812), the processor 210 (collision control module 1425) identifies that the diameter of the size of the collision area CC of the head object 1642 of the player character is R (keeps R as it is) (Step S1814).

In the first embodiment, as an example, there is described a case in which the size of the collision area CC is changed by changing the diameter of the collision area CC, but the element (parameter) of the collision area CC used for changing the size of the collision area CC is not limited thereto, and any value such as a radius may also be used.

Returning to FIG. 18, next, in Step S1815, the processor 210 (collision determination module 1426) determines whether the collision area CC of the head object 1642 of the player character and the collision area CB of the enemy character 1643 have collided (contacted). When it is determined that the collision area CC and the collision area CB of the enemy character 1643 have collided (Yes in Step S1815), the processor 210 (collision determination module 1426) applies a predetermined influence on the player character (Step S1816). For example, the processor 210 (collision determination module 1426) reduces the first parameter associated with the player character. In this case, there is assumed a case in which the first parameter is a required element for continuing the game, such as the health or life of the player character, but this disclosure is not limited thereto.

On the other hand, when it is determined that the collision area CC and the collision area CB of the enemy character 1643 have not collided (No in Step S1815), the processor 210 (collision determination module 1426) does not perform the processing of Step S1816.

Next, in Step S1817, the processor 210 (field-of-view image generation module 1428) generates field-of-view image data of the next frame in consideration of the newest position and posture of the virtual camera 14 and each object in the virtual space 11 and the predetermined influence applied on the player character. Then, the processor 210 (display control module 1429) updates the field-of-view image by outputting and displaying the generated field-of-view image data on the HMD 120.

In this way, in the first embodiment, when the absolute velocity of the HMD 120 is equal to or more than a predetermined velocity, the size of the collision area CC is reduced on the expectation that the user 5 is quickly moving his or her head in order to avoid a collision between the collision area CC of the head object 1642 of the player character and the collision area CB of the enemy character 1643. Therefore, in the first embodiment, it is easier to avoid a situation in which a collision occurs between the collision area CC of the head object 1642 of the player character and the collision area CB of the enemy character 1643 even though the user 5 feels that he or she has avoided the collision (attack) by the enemy character 1643, and hence the sense of immersion of the user 5 in the virtual space may be improved.

In the first embodiment, as an example, there is described a collision between the head object 1642 of the player object and the enemy character 1643 as a cause of to a reduction in the first parameter of the player character, but this disclosure is not limited thereto. For example, in place of the enemy character 1643 itself, a collision between an object (e.g., a spherical object thrown by the enemy character 1643 or a bullet object shot by the enemy character from a pistol) emitted by the enemy character 1643 in order to attack the player character and the head object 1642 of the player character may be the cause of the reduction in the first parameter.

### First Modification Example

The control of the size of the collision area CC described in the first embodiment may be performed only when the enemy character 1643 is moving in the direction of the player character (head object 1642) or the virtual camera 14. Whether the enemy character 1643 is moving in the direction of the player character (head object 1642) or the virtual camera 14 may be determined from the movement direction of the enemy character 1643. The movement direction of the enemy character 1643 may be identified based on a positional relationship between the position of the enemy character 1643 in the current frame and the position of the enemy character 1643 in a past frame (e.g., the direction from the position of the past frame to the position of the current frame may be identified as the movement direction of the enemy character 1643). It is only required that the past frame be a frame prior to the previous frame.

Whether the enemy character 1643 is moving in the direction of the player character (head object 1642) or the virtual camera 14 may be determined, for example, based on whether the player character (head object 1642) or the virtual camera 14 is positioned within a range including a predetermined polar angle centered around the movement direction of the enemy character 1643. In this case, when the player character (head object 1642) or the virtual camera 14 is positioned within the range including a predetermined polar angle centered around the movement direction of the enemy character 1643, the processor 210 (collision control module 1425) may determine that the enemy character 1643 is moving in the direction of the player character (head object 1642) or the virtual camera 14, and perform size control of the collision area CC. On the other hand, when the player character (head object 1642) or the virtual camera 14 is not positioned within the range including a predetermined polar angle centered around the movement direction of the enemy character 1643, the processor 210 (collision control module 1425) may determine that the enemy character 1643 is not moving in the direction of the player character (head object 1642) or the virtual camera 14, and does not perform size control of the collision area CC.

In this way, it is easier to restrict the timing at which the control to reduce the size of the collision area CC is executed to scenes in which the user is expected to quickly move his or her head in order to avoid a collision between the collision area CC of the head object 1642 of the player character and the collision area CB of the enemy character 1643. Therefore, in the first modification example, when the user 5 does not move his or her head quickly to avoid a collision (attack) by the enemy character 1643, it is easier to avoid a reduction in the size of the collision area CC. As a result, it is possible to avoid a situation in which the player character behaves differently from the feeling of the user 5, and hence the sense of immersion of the user 5 in the virtual space may be improved.

### Second Modification Example

In the first embodiment, there is described an example in which the size of the collision area CC is controlled simply based on the absolute velocity of the HMD 120. However, the method of controlling the size of the collision area CC is not limited thereto. For example, the size of the collision area CC may be controlled based on not only the absolute velocity of the HMD 120 but also on the movement direction of the HMD 120. In this case, the processor 210 (collision control module 1425) may control the size of the above-described collision area CC when the movement direction of the HMD 120 is in a predetermined direction and the absolute velocity of the HMD 120 is equal to or more than a predetermined velocity. The movement direction of the HMD 120 may be identified based on the positional relationship between the position of the HMD 120 in the current frame and the position of the HMD 120 in a past frame (e.g., the direction from the past frame position to the current frame position may be identified as the movement direction of the HMD 120). The past frame may be a frame prior to the previous frame.

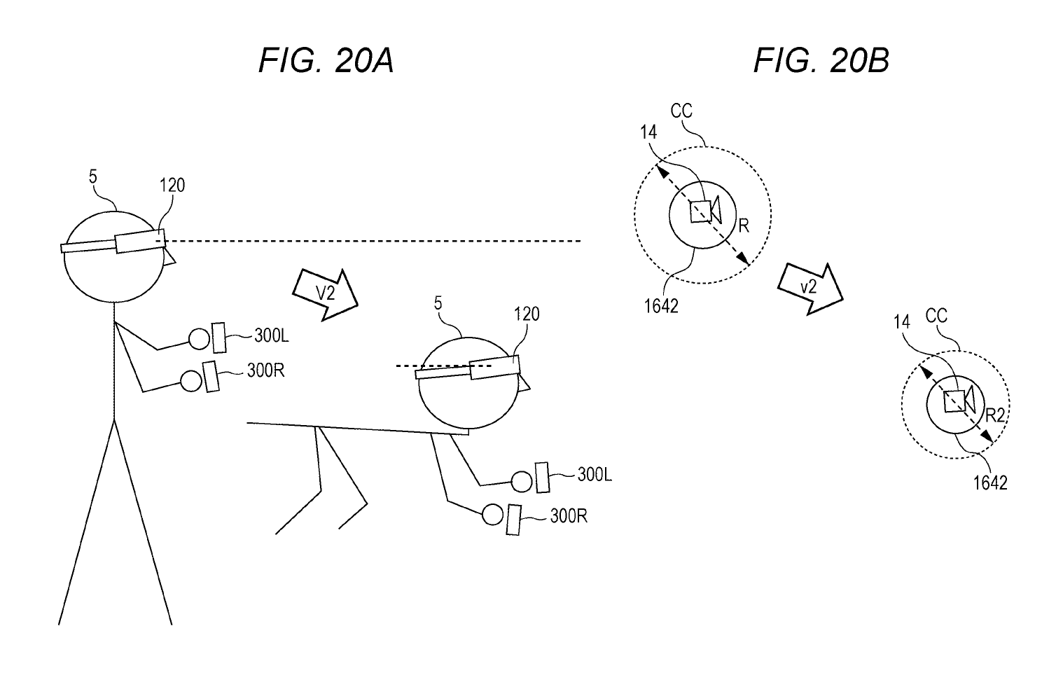

FIG. 20A is a diagram of an example of a state in which the user 5 has moved his or her head downward (state in which user 5 is crouching) according to a modification example of this disclosure. FIG. 20B is a diagram of a control example of the size of the collision area CC of the head object 1642 of the player character in the state of FIG. 20A according to a modification example of this disclosure. In the example of FIG. 20A and FIG. 20B, it is assumed that the user 5 takes an action of crouching down (moves his or her head downward) in order to avoid a collision between the collision area CC of the head object 1642 of the player character and the collision area CB of the enemy character 1643. Therefore, as in FIG. 20A, when the movement direction of the HMD 120 is downward (e.g., −y direction in global coordinate system or −v direction in uvw visual field coordinate system) and the absolute velocity v2 of the HMD 120 is equal to or more than the predetermined velocity vth, as in FIG. 20B, the size of the collision area CC of the head object 1642 of the player character is set to a diameter R2, which is smaller than the diameter R. In the example of FIG. 20A and FIG. 20B, it is not required for the movement direction of the HMD 120 to perfectly match the downward direction, and it is only required that at least a motion in the downward direction be included. For example, when the movement direction of the HMD 120 is broken down into x-axis, y-axis, and z-axis directions in a global coordinate system, it is only required for at least a −y direction to be included, or when the movement direction of the HMD 120 is broken down into u-axis, v-axis, and w-axis directions in a uvw visual field coordinate system, it is only required for at least a −v direction to be included. In the example of FIG. 20A and FIG. 20B, there is described an example in which the predetermined direction is the downward direction, but the predetermined direction is not limited thereto, and may be any direction or a combination of any directions (e.g., moving backward and then moving in a left or a right direction).

In this way, it is easier to restrict the timing at which the control to reduce the size of the collision area CC is executed to scenes in which the user is expected to quickly move his or her head in order to avoid a collision between the collision area CC of the head object 1642 of the player character and the collision area CB of the enemy character 1643. Therefore, in the second modification example, when the user 5 does not move his or her head quickly to avoid a collision (attack) by the enemy character 1643, it is easier to avoid a reduction in the size of the collision area CC. As a result, it is possible to avoid a situation in which the player character behaves differently from the feeling of the user 5, and hence the sense of immersion of the user 5 in the virtual space may be improved.

### Second Embodiment

In the first embodiment, as an example, there is described a case in which when the processor 210 (collision determination module 1426) determines that the collision area CC of the head object 1642 of the player character and the collision area CB of the enemy character 1643 have collided with each other, a first parameter associated with the player character is reduced. However, in a second embodiment of this disclosure, as an example, there is described a case in which when the processor 210 (collision determination module 1426) determines that the collision area CC of the head object 1642 of the player character and the collision area CB of the enemy character 1643 have collided with each other, a second parameter associated with the enemy character 1643 is varied. Specifically, in the second embodiment, the user 5 moves the HMD 120 so as to reduce the second parameter associated with the enemy character 1643, that is, so as to cause the collision area CC of the head object 1642 of the player character and the collision area CB of the enemy character 1643 to collide.

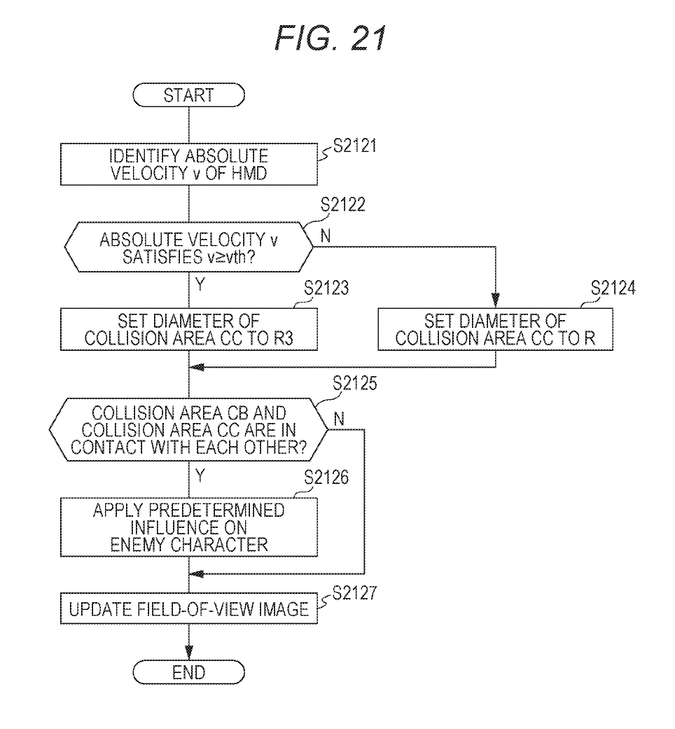

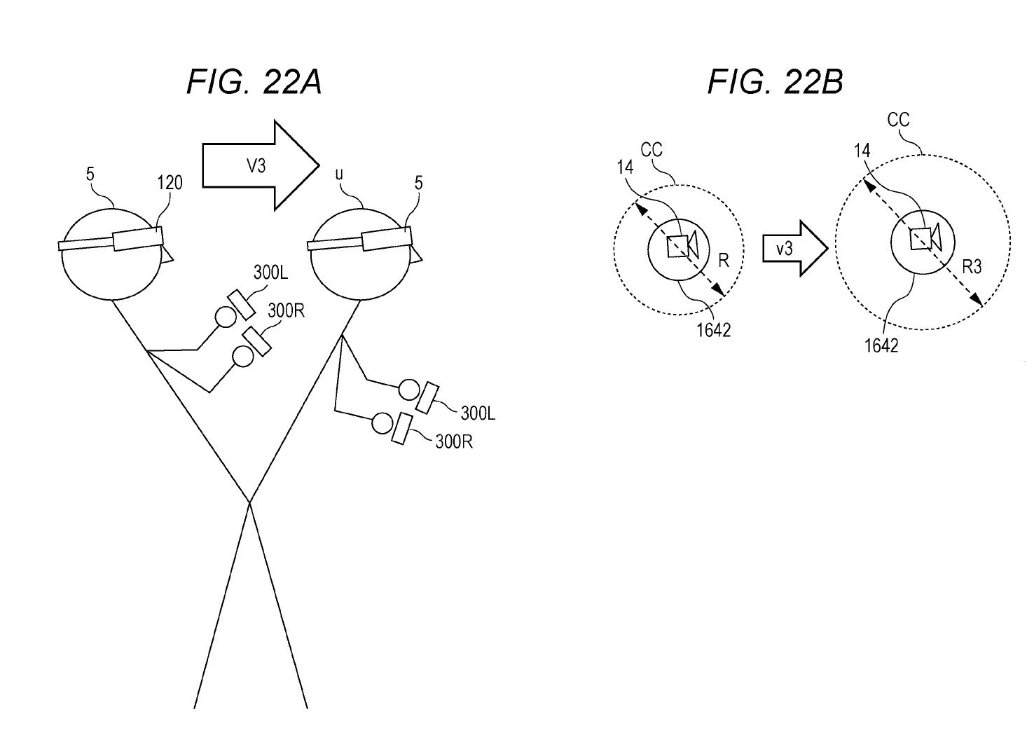

An information processing method, specifically, a method of controlling the size of the collision area, according to the second embodiment of this disclosure is described with reference to FIG. 21, FIG. 22A, and FIG. 22B. FIG. 21 is a flowchart of an example of collision determination processing according to the second embodiment of this disclosure. The collision determination processing of FIG. 21 corresponds to an example of the detailed processing of Step S1508 to Step S1510 of the flowchart of FIG. 15. FIG. 22A is a diagram of an example of a state in which the user 5 has moved his or her head forward according to the second embodiment of this disclosure. FIG. 22B is a diagram of an example of control of the size of the collision area CC of the head object 1642 of the player character in the state of FIG. 22A according to at least one embodiment of this disclosure.

In the second embodiment, as described above, the user 5 moves the HMD 120 so as to cause the collision area CC of the head object 1642 of the player character and the collision area CB of the enemy character 1643 to collide.

The user 5 is wearing the HMD 120 and is viewing the field-of-view image displayed on the monitor 130, and is hence enjoying an experience as if he or she is in the virtual space (immersed in the virtual space). Therefore, in a case in which the user 5 desires to cause a collision between the collision area CC of the head object 1642 of the player character and the collision area CB of the enemy character 1643 (when user 5 wants to head-butt the enemy character 1643 with the head object 1642 of the player character), the user 5 is considered to cause the collision area CC of the head object 1642 of the player character and the collision area CB of the enemy character 1643 to collide with each other by moving his or her head. In this case, in order to improve the sense of immersion of the user 5 in the virtual space, it is preferred to avoid as much as possible a situation in which the collision area CC of the head object 1642 of the player character and the collision area CB of the enemy character 1643 do not collide even though the user 5 feels that his or her head object 1642 has collided with (head-butted) the enemy character 1643.

Therefore, in the second embodiment, the processor 210 (collision control module 1425) increases the size of the collision area CC when the HMD 120 is moving at a predetermined speed or faster.

In FIG. 21, first, in Step S2121, the processor 210 identifies the absolute velocity v of the HMD 120. The details of the processing of Step S2121 are the same as those in the first embodiment, and hence a detailed description thereof is omitted here.

Next, in Step S2122, the processor 210 (collision control module 1425) determines whether the absolute velocity v of the HMD 120 is equal to or more than the predetermined threshold velocity vth. The details of the processing of Step S2122 are the same as those in the first embodiment, and hence a detailed description thereof is omitted here.

Next, when it is determined in Step S2122 that the absolute velocity v of the HMD 120 is equal to or more than the predetermined velocity vth (v≥vth) (Yes in Step S2122), the processor 210 (collision control module 1425) identifies (sets) that the diameter of the size of the collision area CC of the head object 1642 of the player character is R3 (R3>R) (Step S2123). For example, as in FIG. 22A, in order to cause the player character (head object 1642) to head-butt the enemy character 1643, when an absolute velocity v3 of the HMD 120 at a time when the user 5 moves his or her head forward is equal to or more than the predetermined velocity vth, as in FIG. 22B, the size of the collision area CC of the head object 1642 of the player character is set to a diameter R3, which is larger than the diameter R.

On the other hand, when it is determined that the absolute velocity v of the HMD 120 is less than the predetermined velocity vth (v<vth) (No in Step S2122), the processor 210 (collision control module 1425) identifies that the diameter of the size of the collision area CC of the head object 1642 of the player character is R (keeps R as it is) (Step S2124). The details of the processing of Step S2124 are the same as those in the first embodiment, and hence a detailed description thereof is omitted here.

Next, in Step S2125, the processor 210 (collision determination module 1426) determines whether the collision area CC of the head object 1642 of the player character and the collision area CB of the enemy character 1643 have collided. When it is determined that the collision area CC and the collision area CB of the enemy character 1643 have collided (Yes in Step S2125), the processor 210 (collision determination module 1426) applies a predetermined influence on the enemy character 1643 (Step S2126). For example, the processor 210 (collision determination module 1426) reduces the second parameter associated with the enemy character 1643. In this case, there is assumed a case in which the second parameter is a required element for clearing a stage or the game, such as the health or life of the enemy character 1643, but this disclosure is not limited to thereto.

On the other hand, when it is determined that the collision area CC and the collision area CB of the enemy character 1643 have not collided (No in Step S2125), the processor 210 (collision determination module 1426) does not perform the processing of Step S2126.

Next, in Step S2127, the processor 210 (field-of-view image generation module 1428) generates a field-of-view image of the next frame in consideration of the newest position and posture of the virtual camera 14 and each object in the virtual space 1100 and the predetermined influence applied on the enemy character 1643. Then, the processor 210 (display control module 1429) updates the field-of-view image by outputting and displaying the generated field-of-view image on the HMD 120.

In this way, in the second embodiment, when the absolute velocity of the HMD 120 is equal to or more than a predetermined velocity, the size of the collision area CC is increased on the expectation that the user 5 is quickly moving his or her head in order to cause a collision between the collision area CC of the head object 1642 of the player character and the collision area CB of the enemy character 1643. Therefore, in the second embodiment, it is easier to avoid a situation in which the collision area CC of the head object 1642 of the player character and the collision area CB of the enemy character 1643 do not collide even though the user 5 feels that he or she has head-butted (attacked) the enemy character 1643, and hence the sense of immersion of the user 5 in the virtual space may be improved.

### Third Modification Example

The control of the size of the collision area CC described in the second embodiment may be performed only when the player character (head object 1642) or the virtual camera 14 is moving in the direction of the enemy character 1643. Whether the player character (head object 1642) or the virtual camera 14 is moving in the direction of the enemy character 1643 may be determined by the same method as the method described in the first modification example for determining whether the enemy character 1643 is moving in the direction of the player character (head object 1642) or the virtual camera 14.

The processor 210 (collision control module 1425) may determine, when the enemy character 1643 is positioned within a range including a predetermined polar angle centered around the movement direction of the player character (head object 1642) or the virtual camera 14, that the player character (head object 1642) or the virtual camera 14 is moving in the direction of the enemy character 1643, and perform the above-mentioned size control of the collision area CC. On the other hand, the processor 210 (collision control module 1425) may determine, when the enemy character 1643 is not positioned within the range including a predetermined polar angle about the movement direction of the player character (head object 1642) or the virtual camera 14, that the player character (head object 1642) or the virtual camera 14 is not moving in the direction of the enemy character 1643, and not perform size control of the collision area CC.

In this way, it is easier to restrict the timing at which the control of increasing the size of the collision area CC is executed to scenes in which the user 5 is expected to quickly move his or her head in order to cause a collision between the collision area CC of the head object 1642 of the player character and the collision area CB of the enemy character 1643. Therefore, in the third modification example, when the user is not moving his or her head quickly to attack (head-butt) the enemy character 1643, it is easier to avoid an increase in the size of the collision area CC, hence it is possible to avoid a situation in which the player character behaves differently from the feeling of the user 5, and thus the sense of immersion of the user 5 in the virtual space may be improved.

### Fourth Modification Example

In the second embodiment, there is described an example in which the size of the collision area CC is controlled simply based on the absolute velocity of the HMD 120. However, the method of controlling the size of the collision area CC is not limited thereto. For example, similarly to the second modification example, the size of the collision area CC may be controlled based on not only the absolute velocity of the HMD 120 but also on the movement direction of the HMD 120. In this case, the processor 210 (collision control module 1425) may control the size of the above-described collision area CC when the movement direction of the HMD 120 is a predetermined direction and the absolute velocity of the HMD 120 is equal to or more than a predetermined velocity. In this case, the movement direction of the HMD 120 may be identified in the same manner as in the method of the second modification example.

For example, in the example of FIG. 22A and FIG. 22B, it is supposed that the user 5 performs a head-butting action (moves head forward) in order to cause a collision between the collision area CC of the head object 1642 of the player character and the collision area CB of the enemy character 1643. Therefore, in FIG. 22A, when the movement direction of the HMD 120 is the forward direction (+w direction in uvw visual field coordinate system) and the absolute velocity v3 of the HMD 120 is equal to or more than the predetermined velocity vth, as in FIG. 22B, the size of the collision area CC of the head object 1642 of the player character may be set to the diameter R3, which is larger than the diameter R.

In this way, it is easier to restrict the timing at which the control of increasing the size of the collision area CC is executed to scenes in which the user 5 is expected to quickly move his or her head in order to cause a collision between the collision area CC of the head object 1642 of the player character and the collision area CB of the enemy character 1643. Therefore, in the fourth modification example, when the user is not moving his or her head quickly to attack (head-butt) the enemy character 1643, it is easier to avoid an increase in the size of the collision area CC, hence it is possible to avoid a situation in which the player character behaves differently from the feeling of the user 5, and thus the sense of immersion of the user 5 in the virtual space may be improved.

### Third Embodiment

In the first embodiment, there is described an example in which the size of the collision area CC of the head object 1642 of the player character is controlled in accordance with the absolute velocity of the HMD 120. However, depending on the absolute velocity of the HMD 120, the collision between the player character and the enemy character 1643 may be invalidated.

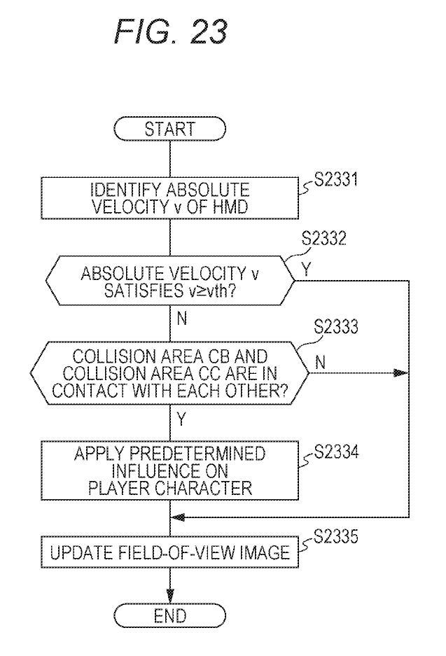

FIG. 23 is a flowchart of an example of collision determination processing according to a third embodiment of this disclosure. The collision determination processing of FIG. 23 corresponds to an example of the detailed processing of Step S1508 to Step S1510 of the flowchart of FIG. 15.

In FIG. 23, first, in Step S2331, the processor 210 identifies the absolute velocity v of the HMD 120. The details of the processing of Step S2331 are the same as those in the first embodiment, and hence a detailed description thereof is omitted here.

Next, in Step S2332, the processor 210 (collision control module 1425) determines whether the absolute velocity v of the HMD 120 is equal to or more than the predetermined threshold velocity vth. The details of the processing of Step S2332 are the same as those in the first embodiment, and hence a detailed description thereof is omitted here.

Next, when it is determined in Step S2332 that the absolute velocity v of the HMD 120 is not equal to or more than the predetermined velocity vth (v<vth) (No in Step S2332), the processor 210 (collision determination module 1426) determines whether the collision area CC of the head object 1642 of the player character and the collision area CB of the enemy character 1643 have collided (Step S2333). When it is determined that the collision area CC of the head object 1642 of the player character and the collision area CB of the enemy character 1643 have collided (Yes in Step S2333), the processor 210 (collision determination module 1426) applies a predetermined influence on the player character (Step S2334).

On the other hand, when it is determined that the absolute velocity v of the HMD 120 is equal to or more than the predetermined velocity vth (v≥vth) (Yes in Step S2332), and when it is determined that the collision area CC and the collision area CB of the enemy character 1643 have not collided (No in Step S2333), the processor 210 (collision determination module 1426) does not perform the processing of Step S2334.

Next, in Step S2335, the processor 210 (field-of-view image generation module 1428) generates a field-of-view image of the next frame in consideration of the newest position and posture of the virtual camera 14 and each object in the virtual space 11 and the predetermined influence applied on the player character. Then, the processor 210 (display control module 1429) updates the field-of-view image by outputting and displaying the generated field-of-view image on the HMD 120.

In the third embodiment, when the absolute velocity of the HMD 120 is equal to or more than the predetermined velocity, a collision between the player character and the enemy character 1643 is invalidated. Therefore, it is easier to avoid a situation in which a collision between the collision area CC of the head object 1642 of the player character and the collision area CB of the enemy character 1643 occurs even though the user 5 feels that he or she has avoided the collision (attack) by the enemy character 1643, and hence the sense of immersion of the user 5 in the virtual space may be improved.

The order of Step S2331 to Step S2333 of the flowchart in FIG. 23 is not limited to the order described above. For example, when the collision area CC of the head object 1642 of the player character and the collision area CB of the enemy character 1643 have collided, whether the absolute velocity of the HMD 120 is equal to or more than a predetermined velocity is determined, and when the absolute velocity of the HMD 120 is equal to or more than the predetermined velocity, the collision between the player character and the enemy character 1643 may be invalidated.

In the description of each of the embodiments of this disclosure, each of the embodiments is described based on a first-person perspective from the player character, but this disclosure is not limited thereto. For example, a virtual camera may be arranged so as to photograph the player character and the enemy character from behind of the player character, and the images photographed from the virtual camera may be set as a field-of-view image. In this case, the virtual camera tracks the movement of the player character and photographs images from behind the player character. In the description of each of the embodiments described above, there are mainly described examples in which the collision area is set as the head object of the player character. However, this disclosure is not limited thereto, and the collision area may be set as the player character itself, for example. In the description of each of the embodiments described above, there are described examples in which the absolute velocity and movement direction of the HMD 120 are used, but this disclosure is not limited thereto. For example, the absolute velocity and movement direction of the virtual camera 14 may be used.

In the description of each of the above-mentioned embodiments, as an example, there is described a case of the virtual space (VR space) in which the user is immersed using the HMD 120. However, a see-through HMD may be adopted as the HMD 120. In this case, the user 5 may be provided with a virtual experience in an augmented reality (AR) space or a mixed reality (MR) space through output of a field-of-view image that is a combination of the real space visually recognized by the user via the see-through HMD device and a portion of an image forming the virtual space. In this case, an action may be exerted on a target object in the virtual space based on motion of the HMD 120 instead of the head object of the player character. Specifically, the processor 210 may identify coordinate information on the position of the HMD 120 in the real space, and define the position of the target object in the virtual space in terms of the relationship with the coordinate information in the real space. With this, the processor 210 may grasp the positional relationship between the HMD 120 in the real space and the target object in the virtual space, and execute processing corresponding to, for example, the above-mentioned collision control between the HMD 120 and the target object. As a result, it is possible to exert an action on the target object based on motion of the HMD 120.

This concludes descriptions of at least one embodiment of this disclosure. However, the descriptions of at least one embodiment are not to be read as a restrictive interpretation of the technical scope of this disclosure. At least one embodiment is merely given as an example, and it is to be understood by a person skilled in the art that various modifications can be made to at least one embodiment within the scope of this disclosure set forth in the appended claims. The technical scope of this disclosure is to be defined based on the scope of this disclosure set forth in the appended claims and an equivalent scope thereof.

The subject matters described herein are described as, for example, the following items.

### (Item 1)

There is provided an information processing method to be executed in a system (e.g., HMD system 100) including a head-mounted display (e.g., HMD 120) and a sensor (e.g., HMD sensor 410) configured to detect a motion of the head-mounted display. The information processing method includes identifying virtual space data defining a virtual space (e.g., virtual space 11) including a virtual camera (e.g., virtual camera 14) associated with a head (e.g., head object 1642) of a player character and a target object (e.g., enemy character 1643) (e.g., Step S1501 of FIG. 15). The information processing method further includes moving the virtual camera based on the motion of the head-mounted display (e.g., Step S1506 of FIG. 15). The information processing method further includes assigning an element for applying an influence on collision determination between the player character and the target object based on information on a speed of the head-mounted display (e.g., Step S1813 and Step S1814 of FIG. 18, Step S2123 and Step S2124 of FIG. 21, and Step S2332 of FIG. 23). The information processing method further includes determining a collision between the player character and the target object based on the assigned element and a positional relationship between a collision area (e.g., collision area CC) associated with the head of the player character or the virtual camera and the target object (e.g., Step S1815 of FIG. 18, Step S2125 of FIG. 21, and Step S2332 and Step S2333 of FIG. 23). The information processing method further includes generating field-of-view image data based on a field of view of the virtual camera defined based on a motion of the virtual camera, the virtual space data, and the collision determination result (e.g., Step S1817 of FIG. 18, Step S2127 of FIG. 21, and Step S2335 of FIG. 23). The information processing method further includes displaying a field-of-view image on the head-mounted display based on the field-of-view image data (Step S1817 of FIG. 18, Step S2127 of FIG. 21, and Step S2335 of FIG. 23).

In the information processing method of Item 1, a collision between the player character and the target object is determined based on the element for applying an influence on the collision determination between the player character and the target object and the positional relationship between the collision area associated with the head of the player character or the virtual camera and the target object. Therefore, it is possible to perform the collision determination between the player character and the target object in a variety of ways, and the user may enjoy an improved virtual experience.

### (Item 2)

The information processing method according to Item 1,

wherein the assigning of the element includes identifying a size of the collision area at a time when the information on the speed of the head-mounted display indicates that the speed is equal to or more than a predetermined speed to be different from the size of the collision area at a time when the information on the speed of the head-mounted display indicates that the speed is less than the predetermined speed (e.g., Step S1812 to Step S1814 of FIG. 18 and Step S2122 to Step S2124 of FIG. 21), and

wherein the determining of the collision includes determining the collision between the player character and the target object based on a positional relationship between the collision area for which the size has been determined and the target object (e.g., Step S1815 of FIG. 18 and Step S2125 of FIG. 21).

In the information processing method of Item 2, the size of the collision area at a time when the information on the speed of the head-mounted display indicates that the speed is equal to or more than a predetermined speed is set to be smaller than the size of the collision area at a time when the information on the speed of the head-mounted display indicates that the speed is less than the predetermined speed. Therefore, with the information processing method of Item 2, a collision determination result different from an ordinary case is obtained when the user wearing the head-mounted display moves his or her head (head-mounted display) at the predetermined speed or faster, and hence the user may enjoy an improved virtual experience.

### (Item 3)

The information processing method according to Item 2, wherein the assigning of the element includes identifying the size of the collision area at a time when the target object is moving in a direction of the player character or the virtual camera and the information on the speed of the head-mounted display indicates that the speed is equal to or more than the predetermined speed to be smaller than the size of the collision area at a time when the information on the speed of the head-mounted display indicates that the speed is less than the predetermined speed (e.g., first modification example).

In the information processing method of Item 3, the size of the collision area at a time when the target object is moving in the direction of the player character or the virtual camera and the information on the speed of the head-mounted display indicates that the speed is equal to or more than the predetermined speed is set to be smaller than the size of the collision area at a time when the information on the speed of the head-mounted display indicates that the speed is less than the predetermined speed. Therefore, with the information processing method of Item 3, it is easier to restrict the timing at which the control of reducing the size of the collision area is executed to scenes in which the user is expected to quickly move his or her head in order to avoid a collision between the head of the player character and the target object. As a result, when the user is not moving his or her head quickly to avoid a collision with the target object, it is easier to avoid a reduction in the size of the collision area, hence it is possible to avoid a situation in which the player character behaves differently from the feeling of the user, and thus the sense of immersion of the user in the virtual space may be improved.

### (Item 4)

The information processing method according to Item 2, wherein the assigning of the element includes identifying the size of the collision area at a time when the player character or the virtual camera is moving in a direction of the target object and the information on the speed of the head-mounted display indicates that the speed is equal to or more than the predetermined speed to be larger than the size of the collision area at a time when the information on the speed of the head-mounted display indicates that the speed is less than the predetermined speed (e.g., third modification example).

In the information processing method of Item 4, the size of the collision area at a time when the player character or the virtual camera is moving in the direction of the target object and the information on the speed of the head-mounted display indicates that the speed is equal to or more than the predetermined speed is set to be larger than the size of the collision area at a time when the information on the speed of the head-mounted display indicates that the speed is less than the predetermined speed. Therefore, with the information processing method of Item 4, it is easier to restrict the timing at which the control of increasing the size of the collision area is executed to scenes in which the user is expected to quickly move his or her head in order to cause a collision between the head of the player character and the target object. As a result, when the user is not moving his or her head quickly to cause a collision with the target object, it is easier to avoid an increase in the size of the collision area, hence it is possible to avoid a situation in which the player character behaves differently from the feeling of the user, and thus the sense of immersion of the user in the virtual space may be improved.

### (Item 5)

The information processing method according to any one of Items 2 to 4, wherein the assigning of the element further includes identifying the size of the collision area based on a movement direction of the head-mounted display (e.g., second and fourth modification examples).

With the information processing method of Item 5, it is easier to restrict the timing at which the control of the size of the collision area is executed to a case in which the user is expected to quickly move his or her head in order to avoid a collision between the head of the player character and the target object or a case in which the user is expected to quickly move his or her head in order to cause a collision between the head of the player character and the target object. Therefore, it is possible to avoid a situation in which the player character behaves differently from the feeling of the user, and thus the sense of immersion of the user in the virtual space may be improved.

### (Item 6)

The information processing method according to Item 1,

wherein the assigning of the element includes assigning information on the speed on the head-mounted display (e.g., Step S2332 of FIG. 23), and

wherein the determining of the collision includes determining, when the information on the speed of the head-mounted display indicates that the speed is equal to or more than the predetermined speed, regardless of the positional relationship between the collision area and the target object, that the player character and the target object have not collided (e.g., Yes in Step S2332 of FIG. 23).

With the information processing method of Item 6, a collision between the player character and the target object is invalidated when the absolute velocity of the head-mounted display is equal to or more than a predetermined velocity, and hence it is easier to avoid a situation in which a collision between the collision area CC of the head of the player character and the target object is not avoided even though the user 5 feels that he or she has avoided the collision by the target object, and thus the sense of immersion of the user in the virtual space may be improved.

### (Item 7)

The information processing method according to anyone of Items 1 to 6, wherein the determining of the collision includes varying a first parameter associated with the player character when it is determined that the player character and the target object have collided.

### (Item 8)

The information processing method according to any one of Items 1 to 6, wherein the determining of the collision includes varying a second parameter associated with the target object when it is determined that the player character and the target object have collided.

### (Item 9)

A program for executing the information processing method of any one of Items 1 to 8 on a computer.

### (Item 10)

A computer for controlling a system including a head-mounted display and a sensor for detecting a motion of the head-mounted display, the computer being configured to execute, under control of a processor included in the computer:

identifying virtual space data defining a virtual space including a virtual camera associated with a head of a player character and a target object;

moving the virtual camera based on the motion of the head-mounted display;

assigning an element for applying an influence on collision determination between the player character and the target object based on information on the speed of the head-mounted display;

determining a collision between the player character and the target object based on the assigned element and a positional relationship between a collision area associated with the head of the player character or the virtual camera and the target object;

generating field-of-view image data based on a field of view of the virtual camera defined based on a motion of the virtual camera, the virtual space data, and the collision determination result; and

displaying a field-of-view image on the head-mounted display based on the field-of-view image data.

What is claimed is:

1. An information processing method, comprising:
defining a virtual space, wherein the virtual space comprises a player character associated with a user, a virtual camera associated with a head of the player character, and a target object;
detecting a motion of a head-mounted device (HMD) associated with the user;
moving the virtual camera in accordance with the motion of the HMD;
identifying a speed of the HMD or the virtual camera;
defining, in accordance with the speed, a condition relating to collision determination between the player character and the target object;
identifying a positional relationship between the player character or the virtual camera and the target object;
executing collision determination between the player character and the target object based on the condition and the positional relationship;
controlling the virtual space in accordance with the collision determination;
defining a visual field in the virtual space in accordance with the motion of the HMD;
generating a visual-field image corresponding to the visual field; and
outputting the visual-field image to the HMD.

2. The method according to claim 1, further comprising:
defining a collision area associated with the player character or the virtual camera;
identifying the positional relationship based on a positional relationship between the collision area and the target object;
setting a size of the collision area to a first size in accordance with the speed being equal to more than a threshold; and
setting the size of the collision area to a second size different from the first size in accordance with the speed being smaller than the threshold.

3. The method according to claim 2, further comprising:
defining a second condition, the second condition comprising:
the target object moving in a direction approaching the player character or the virtual camera; and
the speed of the HMD being equal to or more than the threshold; and
setting the size of the collision area to a third size smaller than the second size in accordance with satisfaction of the second condition.

4. The method according to claim 2, further comprising:
defining a third condition, the third condition comprising:
the player character or the virtual camera moving in a direction approaching the target object; and
the speed of the HMD being equal to or more than the threshold; and
setting the size of the collision area to a fourth size larger than the second size in accordance with satisfaction of the third condition.

5. The method according to claim 2, further comprising:
detecting a movement direction of the HMD; and
changing the size of the collision area in accordance with the movement direction.

6. The method according to claim 1, further comprising determining that the player character and the target object have not collided with each other in accordance with the speed of the HMD being equal to or more than the threshold regardless of the positional relationship.

7. The method according to claim 1, further comprising varying a first parameter associated with the player character in accordance with the collision determination.

8. The method according to claim 1, further comprising varying a second parameter associated with the target object in accordance with the collision determination.
